(19) United States
(12) Patent Application Publication
(10) Pub. No.: US 2025/0156998 A1
(43) Pub. Date: May 15, 2025

(54) IMAGE PROCESSING DEVICE

(71) Applicant: Sony Semiconductor Solutions Corporation, Kanagawa (JP)

(72) Inventors: Atsushi Totsuka, Tokyo (JP); Kotoko Hiraoka, Kanagawa (JP)

(21) Appl. No.: 18/720,355

(22) PCT Filed: Jan. 19, 2023
(86) PCT No.: PCT/JP2023/001447

§ 371 Date: Jun. 14, 2024

(30) Foreign Application Priority Data
Feb. 3, 2022 (JP) 2022-015680

(51) Int. Cl. G06T 5/50; G06T 5/20

(52) U.S. Cl. CPC G06T 5/50; G06T 5/20; G06T 2207/20104

(57) ABSTRACT

An image processing device (100) includes a control unit (130). The control unit (130) acquires a plurality of polarized images (M2) having different polarization directions. The control unit (130) outputs a corrected image in which a specific region (CR) included in a specular reflection region (SR) is corrected on the basis of the plurality of polarized images (M2).

### FIELD

The present disclosure relates to an image processing device.

### BACKGROUND

Conventionally, technology for removing an image reflected on a subject included in an image is known. For example, there is technology of removing a reflected image by using captured images captured through polarizing plates having different polarization directions. For example, in such technology, a luminance value of a certain pixel is approximated by a trigonometric function having a polarization angle as a variable. An imaging device of such technology removes a reflected image by setting the luminance value of a reflected image to the minimum value of a trigonometric function curve.

### CITATION LIST

### Patent Literature

Patent Literature 1: JP 2020-166761 A

### SUMMARY

### Technical Problem

However, if regular reflection light components (specular components) of a subject included in a captured image are uniformly removed, texture information of the subject may be impaired.

Therefore, the present disclosure provides a mechanism capable of correcting a reflected image in a subject while maintaining the texture of the subject included in a captured image.

Note that the above problem or object is merely one of a plurality of problems or objects that can be solved or achieved by a plurality of embodiments disclosed herein.

### Solution to Problem

An image processing device of the present disclosure includes a control unit. The control unit acquires a plurality of polarized images having different polarization directions. The control unit outputs a corrected image in which a specific region included in a specular reflection region is corrected on the basis of the plurality of polarized images.

### BRIEF DESCRIPTION OF DRAWINGS

FIG. 1A is a diagram for explaining an example of reflected image correction processing.

FIG. 1B is a diagram for explaining an overview of reflected image correction processing according to an embodiment of the present disclosure.

FIG. 2 is a block diagram illustrating a configuration example of an image processing system according to the embodiment of the disclosure.

FIG. 3 is a diagram illustrating an example of a polarized image according to the embodiment of the disclosure.

FIG. 4 is a diagram illustrating another example of a polarized image according to the embodiment of the disclosure.

FIG. 5 is a diagram illustrating an example of a relationship between the luminance value and the polarization angle of a polarized image according to the embodiment of the disclosure.

FIG. 6 is a block diagram illustrating a configuration example of a correction region determining unit according to the embodiment of the disclosure.

FIG. 7 is a block diagram illustrating a configuration example of a correction region determining unit according to the embodiment of the disclosure.

FIG. 8 is a block diagram illustrating a configuration example of a correction processing unit according to the embodiment of the disclosure.

FIG. 9 is a diagram for explaining an example of reflected image correction by low-pass filter processing according to the embodiment of the disclosure.

FIG. 10 is a graph for explaining an example of reflected image correction by low-pass filter processing according to the embodiment of the disclosure.

FIG. 11 is a diagram for explaining an example of reflected image correction by pixelation processing according to the embodiment of the disclosure.

FIG. 12 is a diagram for explaining an example of reflected image correction by saturation suppression processing according to the embodiment of the disclosure.

FIG. 13 is a diagram for explaining an example of intensity determined by an intensity determining unit according to the embodiment of the disclosure,

FIG. 14 is a diagram for describing an example of correction by an image correction unit according to the embodiment of the disclosure.

FIG. 15A is a diagram for describing another example of correction by the image correction unit according to the embodiment of the disclosure.

FIG. 15B is a diagram for describing another example of correction by the image correction unit according to the embodiment of the disclosure.

FIG. 16 is a diagram for describing another example of correction by the image correction unit according to the embodiment of the disclosure.

FIG. 17 is a flowchart illustrating an example of a flow of reflected image correction processing according to the embodiment of the disclosure.

FIG. 18 is a diagram for describing an example of a flow of processing by AI according to the embodiment of the disclosure.

FIG. 19 is a table for explaining an example of a region determination model according to a first modification of the embodiment of the disclosure.

FIG. 20 is a table for explaining an example of input data and output data of a region determination model according to the first modification of the embodiment of the disclosure.

FIG. 21 is a table for explaining an example of a correction model according to the first modification of the embodiment of the disclosure.

FIG. 22 is a table for explaining an example of input data and output data of the correction model according to the first modification of the embodiment of the disclosure.

FIG. 23 is a block diagram illustrating a configuration example of a correction region determining unit and a correction processing unit according to a second modification of the embodiment of the disclosure.

FIG. 24 is a table for explaining an example of a reflection determination model according to the second modification of the embodiment of the disclosure.

FIG. 25 is a table for explaining an example of input data and output data of a reflection determination model according to the second modification of the embodiment of the disclosure.

FIG. 26 is a table for explaining an example of an image specifying model according to the second modification of the embodiment of the disclosure.

FIG. 27 is a table for explaining an example of input data and output data of the image specifying model according to the second modification of the embodiment of the disclosure.

FIG. 28 is a table for explaining an example of a second correction model according to the second modification of the embodiment of the disclosure.

FIG. 29 is a table for explaining an example of input data and output data of the second correction model according to the second modification of the embodiment of the disclosure.

FIG. 30 is a block diagram illustrating an example of an image correction processing unit according to a third modification of the embodiment of the disclosure.

FIG. 31 is a table for explaining an example of a reflected image correction model according to the third modification of the embodiment of the disclosure.

FIG. 32 is a table for explaining an example of input data and output data of the reflected image correction model according to the third modification of the embodiment of the disclosure.

FIG. 33A is a diagram for explaining an example of the imaging environment according to the embodiment of the disclosure.

FIG. 33B is a diagram for explaining an example of the imaging environment according to the embodiment of the disclosure.

FIG. 33C is a diagram for explaining an example of the imaging environment according to the embodiment of the disclosure.

FIG. 34 is a diagram illustrating an example of an image output by the image processing system according to the embodiment of the disclosure.

FIG. 35A is a diagram for explaining another example of the imaging environment according to the embodiment of the disclosure.

FIG. 35B is a diagram for explaining another example of the imaging environment according to the embodiment of the disclosure.

FIG. 36 is a diagram for explaining reflected image correction performed by the image processing system according to the embodiment of the disclosure.

FIG. 37 is a diagram illustrating another example of an image output by the image processing system according to the embodiment of the disclosure.

FIG. 38 is a diagram for explaining another example of the corrected image according to the embodiment of the disclosure.

FIG. 39 is a diagram for explaining another example of the corrected image according to the embodiment of the disclosure.

FIG. 40 is a diagram for explaining another example of the corrected image according to the embodiment of the disclosure.

FIG. 41 is a diagram illustrating an example of the background according to the embodiment of the present disclosure.

FIG. 42 is a hardware configuration diagram illustrating an example of a computer that implements functions of an information processing device such as the image processing device.

### DESCRIPTION OF EMBODIMENTS

Hereinafter, embodiments of the disclosure will be described in detail by referring to the accompanying drawings. Note that, in the present specification and the drawings, components having substantially the same functional configuration are denoted by the same symbols, and redundant description is omitted.

Furthermore, in the present specification and the drawings, specific values may be indicated to give description; however, the values are merely examples, and other values may be applied.

In addition, in the present specification and the drawings, similar components of embodiments may be distinguished by attaching different alphabets or numbers after the same symbol. Note that, in a case where it is not necessary to particularly distinguish each of similar components, only the same symbol is assigned.

One or more embodiments (including examples and modifications) described below can be each implemented independently. Meanwhile, at least a part of the plurality of embodiments described below may be combined with and implemented together with at least a part of another embodiment as appropriate. The plurality of embodiments may include novel features different from each other. Therefore, the plurality of embodiments can contribute to solving different objects or disadvantages and achieve different effects.

### 1. Introduction

### <1.1. Overview of Reflected Image Correction Processing>

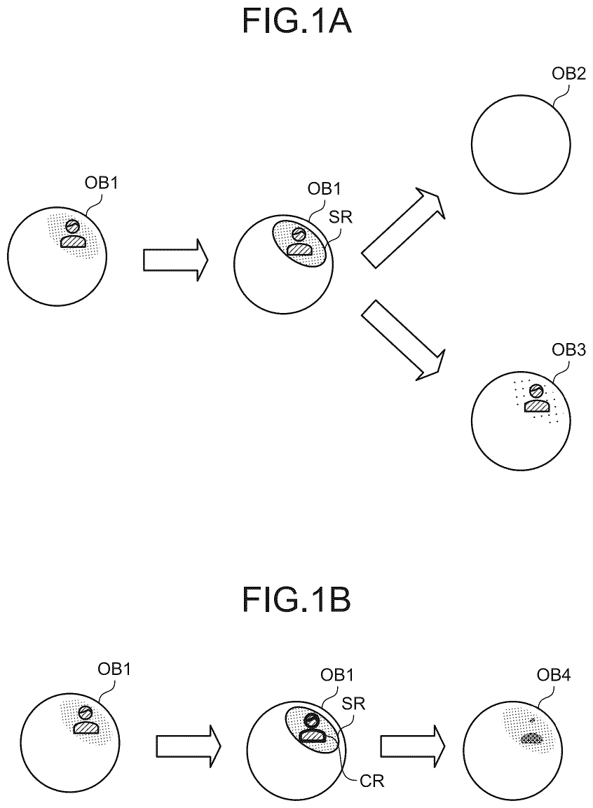

An example of the reflected image correction processing will be described with reference to FIG. 1A. FIG. 1A is a diagram for explaining an example of reflected image correction processing. As illustrated in FIG. 1A, let us assume that a person is reflected in a reflection region of a spherical object OB1 in a case where the object OB1 is imaged.

Meanwhile, a captured image used for the reflected image correction processing is a plurality of captured images (hereinafter, also referred to as polarized images) having different polarization directions. The reflected image correction processing is executed by, for example, an image processing device (not illustrated).

For example, in the reflected image correction processing illustrated in FIG. 1A, the image processing device specifies a reflection region SR in which the person is reflected in the subject (object) OB1.

In FIG. 1A, the image processing device uniformly corrects the reflection region SR. For example, it is based on the premise that the image processing device performs reflected image correction processing of removing all the specular components in the reflection region SR. In this case, as illustrated in the upper-right diagram in FIG. 1A, a captured image including a subject OB2 from which the entire reflection region SR has been removed is generated.

Alternatively, it is based on the premise that the image processing device performs reflected image correction processing of removing some of the specular components in the reflection region SR. In this case, as illustrated in the lower-right diagram in FIG. 1A, a captured image including a subject OB3 is generated, the subject OB3 in which the reflection region SR is reduced to such an extent that what is reflected is unclear.

As described above, when the image processing device performs correction to uniformly remove all or some of the specular components in the reflection region SR, the texture in the reflection region SR is also corrected.

Therefore, the reflected image correction processing according to the embodiment of the disclosure corrects a reflected image region (an example of the specific region) included in the reflection region SR (an example of the specular reflection region).

FIG. 1B is a diagram for explaining an overview of reflected image correction processing according to an embodiment of the present disclosure. The reflected image correction processing in FIG. 1B is executed by an image processing device on the basis of a plurality of polarized images each having different polarization directions.

The image processing device specifies the reflection region SR of the subject OB1 included in the polarized images and a reflected image region CR in the reflection region SR on the basis on the polarized images. The image processing device corrects the reflected image region CR. As a result, as illustrated in the right diagram of FIG. 1B, correction processing is performed on the person in the reflection. Therefore, the image processing device can correct the reflection such that what is reflected with respect to the person in the reflection is unclear while leaving the texture of the reflection region SR.

### 2. Image Processing System

### [Configuration Example of Image Processing System 10]

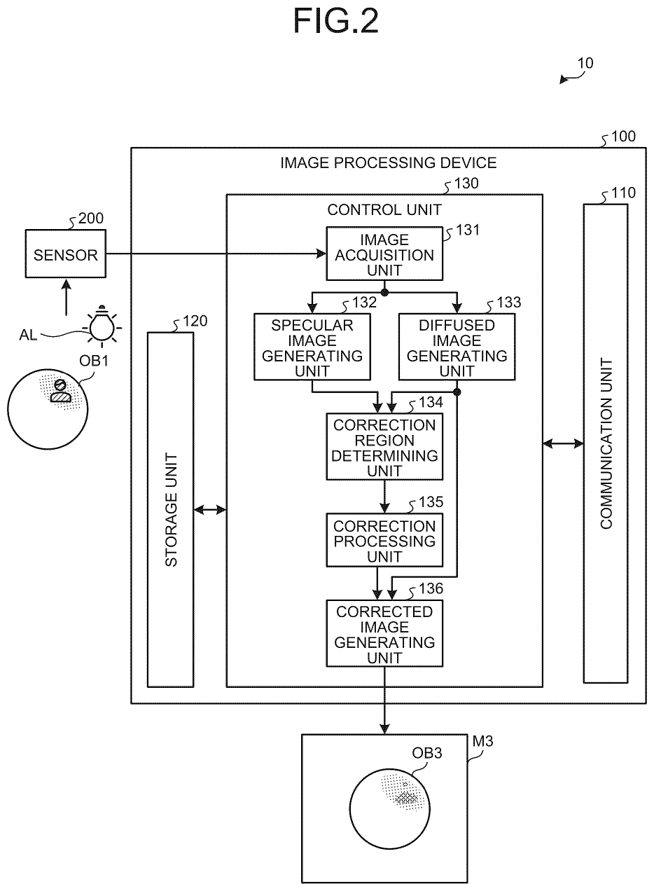

FIG. 2 is a block diagram illustrating a configuration example of an image processing system 10 according to the embodiment of the disclosure. As illustrated in FIG. 2, the image processing system 10 includes an image processing device 100 and a sensor 200. In the example of FIG. 2, the sensor 200 images the subject OB1 under ambient light AL, and the image processing device 100 outputs an output image M3.

### [Sensor 200]

The sensor 200 is an imaging device (polarization sensor) that captures a plurality of captured images (polarized images) having different polarization directions. The sensor 200 includes, for example, a light receiving unit (not illustrated) including a plurality of polarizing filters having different polarization directions. The sensor 200 generates polarized images depending on the amount of light received by the light receiving unit via the polarizing filters.

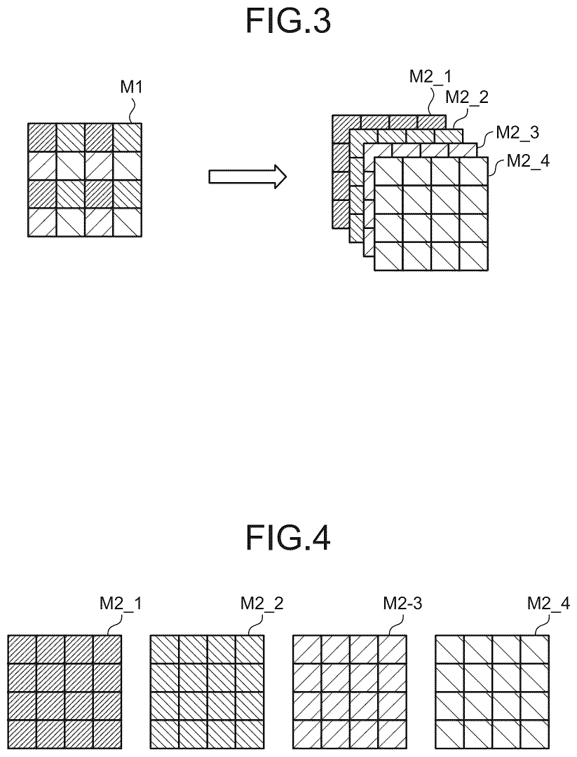

FIG. 3 is a diagram illustrating an example of polarized images according to the embodiment of the disclosure.

The sensor 200 has, for example, the light receiving unit (not illustrated) in which four polarizing filters having different polarization angles are arrayed in a lattice pattern. For example, as illustrated in the left diagram of FIG. 3, the sensor 200 generates a polarized image M1 having a different polarization angle for each pixel. The polarized image M1 includes a plurality of pixels having luminance values of light at polarization angles of 0°, 45°, 90°, and 135°. In the left diagram of FIG. 3, for example, a predetermined pixel has a luminance value of a polarization angle different from those of adjacent pixels.

As illustrated in the right diagram of FIG. 3, the sensor 200 generates a plurality of polarized images M2_1 to M2_4 for the respective polarization angles from the polarized image M1, for example. Note that the polarized image M2_1 is, for example, a polarized image having the polarization angle of 0°, and the polarized image M2_2 is a polarized image having the polarization angle of 45°. Furthermore, the polarized image M2_3 is a polarized image having the polarization angle of 90°, and the polarized image M2_4 is a polarized image having the polarization angle of 135°.

The sensor 200 outputs the generated polarized images M2_1 to M2_4 to the image processing device 100.

Note that, in this example, it is based on the premise that the sensor 200 generates the plurality of polarized images M2_1 to M2_4 for the respective polarization directions from the polarized image M1 including pixels having different polarization directions (polarization angles); however, it is not limited thereto. For example, as illustrated in FIG. 4, the sensor 200 may directly generate the polarized images M2_1 to M2_4 from output of the light receiving unit (not illustrated) including the plurality of polarizing filters having different polarization directions. Note that FIG. 4 is a diagram illustrating another example of polarized images according to the embodiment of the disclosure.

Alternatively, the sensor 200 may include a plurality of light receiving units (not illustrated) for respective polarization directions and generate the polarized images M2_1 to M2_4 corresponding to the respective light receiving units.

Furthermore, in this example, the sensor 200 generates the polarized images M2_1 to M2_4 in the four polarization directions; however, it is not limited thereto. The sensor 200 only needs to generate a plurality of polarized images M2_1 to M2_4 having different polarization directions, and the number of polarization directions may be three or less or five or more.

Furthermore, in this example, the sensor 200 outputs the polarized images M2_1 to M2_4 for the respective polarization directions to the image processing device 100; however, it is not limited thereto. For example, the sensor 200 may output the polarized image M1 to the image processing device 100. In this case, the image processing device 100 converts the polarized image M1 into the polarized images M2_1 to M2_4 for the respective polarization directions.

### [Image Processing Device 100]

Returning to FIG. 2, the image processing device 100 outputs the output image M3 in which the reflection on the subject OB1 is reduced on the basis of, for example, the polarized images M2_1 to M2_4 output from the sensor 200.

As illustrated in FIG. 2, the image processing device 100 includes a communication unit 110, a storage unit 120, and a control unit 130.

### (Communication Unit 110)

The communication unit 110 is implemented by, for example, a communication device and communicates with other devices via various wired or wireless networks. For example, the communication unit 110 receives data of a captured image (for example, the polarized images M2) from another device such as the sensor 200 and stores the data in the storage unit 120. Furthermore, for example, the communication unit 110 transmits data of an image (for example, the output image M3) edited in the image processing device 100 and stored in the storage unit 120 to another device. Furthermore, although not illustrated, in a case where the image processing device 100 is a server, the communication unit 110 receives a command such as a request for processing transmitted from a terminal device (not illustrated) that receives provision of the service and provides the command to each unit of the image processing device 100.

### (Storage Unit 120)

The storage unit 120 is a storage device capable of reading and writing data, such as a dynamic random access memory (DRAM), a static random access memory (SRAM), a flash memory, or a hard disk. The storage unit 120 temporarily or permanently stores various types of data used in the image processing device 100.

For example, the storage unit 120 at least temporarily stores data of a captured image received by the communication unit 110 from another device such as the sensor 200 and provides the data to the control unit 130 as necessary. Furthermore, for example, the storage unit 120 at least temporarily stores data of an image edited by the control unit 130 and provides the data to the communication unit 110 for transmission to another device as necessary. Alternatively, the storage unit 120 may provide the data of the edited image to a display device (not illustrated) for display,

### (Control Unit 130)

The control unit 130 is a controller that controls each unit of the image processing device 100. The control unit 130 is implemented by, for example, a processor such as a central processing unit (CPU), a micro processing unit (MPU), or a graphics processing unit (GPU). For example, the control unit 130 is implemented by a processor executing various programs stored in a storage device inside the image processing device 100 using a random access memory (RAM) or the like as a work area. Note that the control unit 130 may be implemented by an integrated circuit such as an application specific integrated circuit (ASIC) or a field programmable gate array (FPGA). Any of the CPU, the MPU, the GPU, the ASIC, and the FPGA can be regarded as a controller.

The control unit 130 includes an image acquisition unit 131, a specular image generating unit 132, a diffused image generating unit 133, a correction region determining unit 134, a correction processing unit 135, and a corrected image generating unit 136. Each of the blocks (image acquisition unit 131 to corrected image generating unit 136) included in the control unit 130 is a functional block indicating a function of the control unit 130, These functional blocks may be software blocks or hardware blocks. For example, each of the functional blocks described above may be one software module implemented by software (including microprograms) or may be one circuit block on a semiconductor chip (die). It is naturally understood that each of the functional blocks may be one processor or one integrated circuit. The control unit 130 may be constituted by functional units different from the above-described functional blocks. The functional blocks may be configured in any manner.

Note that the control unit 130 may include functional units different from the above-described functional blocks. In addition, some or all of the actions of the blocks (image acquisition unit 131 to corrected image generating unit 136) included in the control unit 130 may be performed by another device. For example, the sensor 200 may perform some or all of the actions of the blocks included in the control unit 130,

### (Image Acquisition Unit 131)

The image acquisition unit 131 acquires the polarized images M2 from the sensor 200. Alternatively, the image acquisition unit 131 may acquire the polarized images M2 from the storage unit 120 or may acquire the polarized images M2 from another device via the communication unit 110. The image acquisition unit 131 outputs the acquired polarized images M2 to the specular image generating unit 132 and the diffused image generating unit 133.

### (Specular Image Generating Unit 132)

The specular image generating unit 132 generates a specular image on the basis of the polarized images M2. The specular image is an image having a luminance value of a specular component (reflection component) for each pixel.

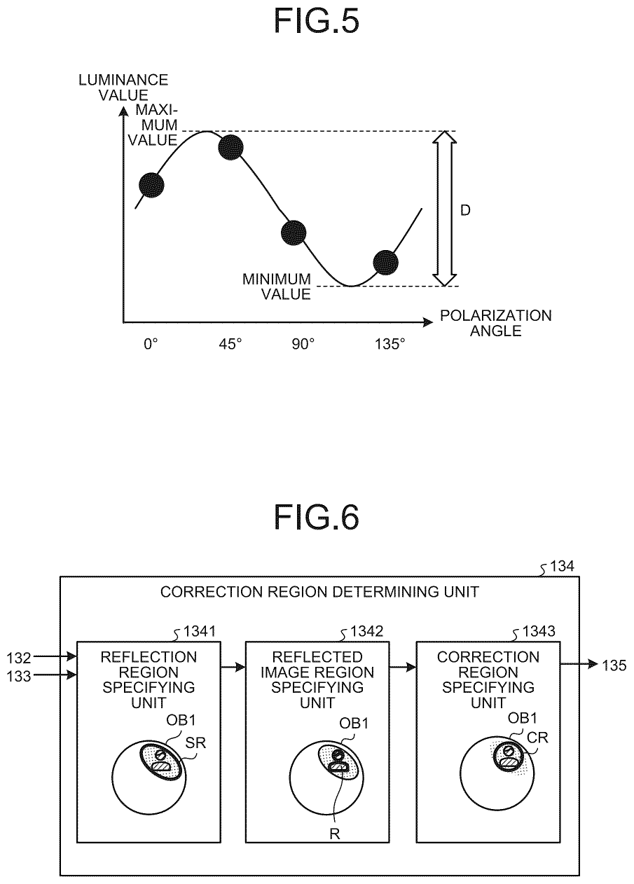

FIG. 5 is a diagram illustrating an example of a relationship between the luminance value and the polarization angle of the polarized images M2 according to the embodiment of the disclosure. In FIG. 5, the horizontal axis represents the polarization angle of the polarized images M2, and the vertical axis represents the luminance value of each pixel. As illustrated in FIG. 5, the luminance values of pixels at the same position in the plurality of polarized images M2_1 to M4 can be approximated as a trigonometric function having the polarization angle as a variable.

The specular image generating unit 132 generates a specular image using a difference D between the maximum value and the minimum value of the luminance values approximated as a trigonometric function as the luminance value of a predetermined image. Alternatively, the specular image generating unit 132 may generate a specular image using the maximum value of the luminance values approximated as the trigonometric function as the luminance value of a predetermined pixel.

Note that the specular image generating unit 132 may calculate the luminance value of the specular image for each pixel of the polarized images M2 or may calculate the luminance value of the specular image for each pixel block including a plurality of pixels.

Furthermore, in this example, the specular image generating unit 132 calculates the luminance value of the specular image by approximating the luminance value of the polarized images M2 as a trigonometric function; however, it is not limited thereto. For example, the specular image generating unit 132 sets the maximum luminance value or a difference D between the maximum value and the minimum value among luminance values of pixels located at the same position in the plurality of polarized images M2 as the luminance value of the specular image at that position.

For example, in a case where the specular image is generated on the basis of two polarized images M2, the specular image generating unit 132 generates the specular image in which larger ones of luminance values of pixels of the two polarized images M2 are set as luminance values of the pixels. Alternatively, the specular image generating unit 132 generates a specular image in which the difference D between the luminance values of the pixels of the two polarized images M2 is set as the luminance value of the pixels.

Returning to FIG. 2, the specular image generating unit 132 outputs the generated specular image to the correction region determining unit 134.

### (Diffused Image Generating Unit 133)

The diffused image generating unit 133 illustrated in FIG. 2 generates a diffused image on the basis of the polarized images M2. The diffused image is an image having a luminance value of a diffusion component (non-reflection component) for each pixel.

As described above, the luminance values of pixels at the same position in the plurality of polarized images M2_1 to M4 can be approximated as the trigonometric function having the polarization angle as the variable (see FIG. 5).

The diffused image generating unit 133 generates the diffused image using the minimum value of the luminance values approximated as the trigonometric function as the luminance value of a predetermined image. Note that the diffused image generating unit 133 may calculate the luminance value of the diffused image for each pixel of the polarized images M2 or may calculate the luminance value of the diffused image for each pixel block including a plurality of pixels.

Furthermore, in this example, the diffused image generating unit 133 calculates the luminance value of the diffused image by approximating the luminance value of the polarized images M2 as the trigonometric function; however, it is not limited thereto. For example, the diffused image generating unit 133 sets the minimum luminance value among luminance values of pixels located at the same position in the plurality of polarized images M2 as the luminance value of the diffused image at that position.

For example, in a case where the diffused image is generated on the basis of the two polarized images M2, the diffused image generating unit 133 generates the diffused image in which smaller ones of luminance values of pixels of the two polarized images M2 are set as luminance values of the pixels.

The diffused image generating unit 133 illustrated in FIG. 2 outputs the generated diffused image to the correction region determining unit 134 and the corrected image generating unit 136.

### (Correction Region Determining Unit 134)

The correction region determining unit 134 determines a correction region to be subjected to reflected image correction on the basis of the polarized images M2.

FIG. 6 is a block diagram illustrating a configuration example of the correction region determining unit 134 according to the embodiment of the disclosure. The correction region determining unit 134 illustrated in FIG. 6 includes a reflection region specifying unit 1341, a reflected image region specifying unit 1342, and a correction region specifying unit 1343.

### (Reflection Region Specifying Unit 1341)

The reflection region specifying unit 1341 specifies a specular reflection region SR in the specular image using the specular image and the diffused image.

For example, the reflection region specifying unit 1341 selects a pixel having a luminance value larger than a first threshold (luminance threshold) from a difference image between the specular image and the diffused image. The reflection region specifying unit 1341 divides selected pixels into at least one or more pixel groups, a pixel group consisting of pixels in contact with each other.

The reflection region specifying unit 1341 determines a pixel group having an area larger than a second threshold among the pixel groups as the reflection region. In other words, the reflection region specifying unit 1341 determines a pixel group in which the number of pixels included in a pixel group is larger than the second threshold as the reflection region. The reflection region specifying unit 1341 determines, in the specular image, the same region as the determined reflection region as the specular reflection region SR.

The reflection region specifying unit 1341 outputs information regarding the specular reflection region SR to the reflected image region specifying unit 1342.

### (Reflected Image Region Specifying Unit 1342)

The reflected image region specifying unit 1342 specifies a reflected image region included in the specular reflection region SR on the basis of the specular image.

The reflected image region specifying unit 1342 determines an image included in the specular reflection region SR on the basis of a change in the luminance value of a detection result of edges of the specular reflection region SR of the specular image. The reflected image region specifying unit 1342 determines the image as the reflected image region R.

The reflected image region specifying unit 1342 outputs information regarding the determined reflected image region R to the correction region specifying unit 1343.

### (Correction Region Specifying Unit 1343)

The correction region specifying unit 1343 specifies a correction region CR to be subjected to the reflected image correction processing on the basis of the specular image.

The correction region specifying unit 1343 determines, for example, a region including the reflected image region R as the correction region CR. The region may have a predefined shape or may have a shape designated by a user. Illustrated in FIG. 6 is a case where the correction region CR is circular; however, the shape of the correction region CR is not limited to circular, and may be rectangular, elliptical, or polygonal.

In addition, illustrated FIG. 6 is a case where the correction region specifying unit 1343 specifies the correction region CR larger than the reflected image region R; however, it is not limited thereto. The correction region specifying unit 1343 may specify the reflected image region R as the correction region CR.

The correction region specifying unit 1343 outputs information regarding the specified correction region CR to the correction processing unit 135.

### (Correction Region Determining Unit 134A)

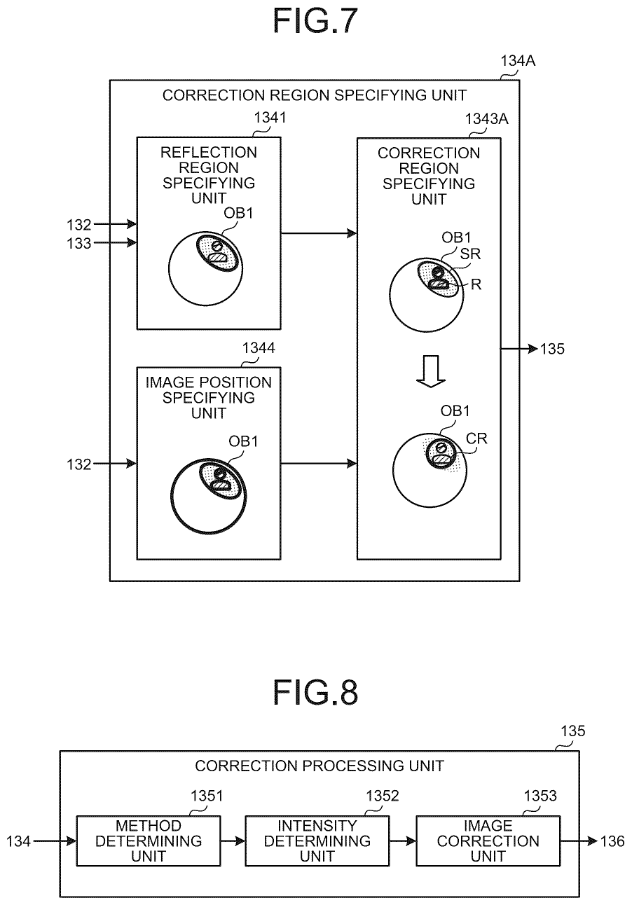

The correction region determining unit 134 is not limited to the configuration illustrated in FIG. 6. Another configuration example of the correction region determining unit 134 will be described with reference to FIG. 7.

FIG. 7 is a block diagram illustrating a configuration example of a correction region determining unit 134A according to an embodiment of the disclosure. The correction region determining unit 134A illustrated in FIG. 7 includes a correction region specifying unit 1343A instead of the correction region specifying unit 1343 in FIG. 6. In addition, the correction region determining unit 134A illustrated in FIG. 7 includes an image position specifying unit 1344 instead of the reflected image region specifying unit 1342.

### (Image Position Specifying Unit 1344)

The image position specifying unit 1344 specifies an image (object) included in the specular image. For example, the image position specifying unit 1344 detects an image included in the specular image and the position of the image on the basis of a change in the luminance value of the specular image or a detection result of edges. For example, the image position specifying unit 1344 can specify the subject OB1 or the specular reflection region SR as images included in the specular image in addition to the image (reflected image region R) reflected on the subject OB1.

The image position specifying unit 1344 outputs information regarding the specified image to the correction region specifying unit 1343A.

Note that, in this example, the image position specifying unit 1344 specifies the image on the basis of the specular image; however, it is not limited thereto. For example, the image position specifying unit 1344 may specify the image on the basis of the diffused image or may specify the image on the basis of the diffused image and the specular image.

### (Correction Region Specifying Unit 1343A)

The correction region specifying unit 1343A specifies the correction region CR on the basis of the specular reflection region SR specified by the reflection region specifying unit 1341 and the image specified by the image position specifying unit 1344.

The correction region specifying unit 1343A first specifies an image located in the specular reflection region SR among the images specified by the image position specifying unit 1344. For example, the correction region specifying unit 1343A specifies an image located in the specular reflection region SR as the reflected image region R.

The correction region specifying unit 1343A specifies the correction region CR to be subjected to the reflected image correction processing on the basis of the reflected image region R. The processing of specifying the correction region CR is the same as the processing in the correction region specifying unit 1343 in FIG. 6.

The correction region specifying unit 1343A outputs information regarding the specified correction region CR to the correction processing unit 135,

### (Correction Processing Unit 135)

Returning to FIG. 2, the correction processing unit 135 corrects a reflected image in the specular image on the basis of the specular image and the correction region CR determined by the correction region determining unit 134. The correction processing unit 135 executes reflected image correction on the correction region CR of the specular image.

FIG. 8 is a block diagram illustrating a configuration example of a correction processing unit 135 according to the embodiment of the disclosure. The correction processing unit 135 illustrated in FIG. 8 includes a method determining unit 1351, an intensity determining unit 1352, and an image correction unit 1353.

### (Method Determining Unit 1351)

The method determining unit 1351 determines a reflected image correction method to be performed on the correction region CR. For example, the method determining unit 1351 determines a method to be actually performed from among a plurality of methods defined in advance. The method determining unit 1351 may determine the method in accordance with, for example, an instruction from the user or may determine a predefined method as a method to be actually performed. Alternatively, the method determining unit 1351 may determine the method depending on the type of the image (such as characters or a person) reflected in the specular reflection region SR.

The method determining unit 1351 outputs information regarding the determined correction method to the intensity determining unit 1352.

Here, three methods of low-pass filter processing, pixelation processing, and saturation suppression processing will be described as examples of the reflected image correction method determined by the method determining unit 1351. Note that the correction methods described here are examples, and the correction processing unit 135 may perform the reflected image correction by a method other than the three types of processing,

### (Low-Pass Filter Processing)

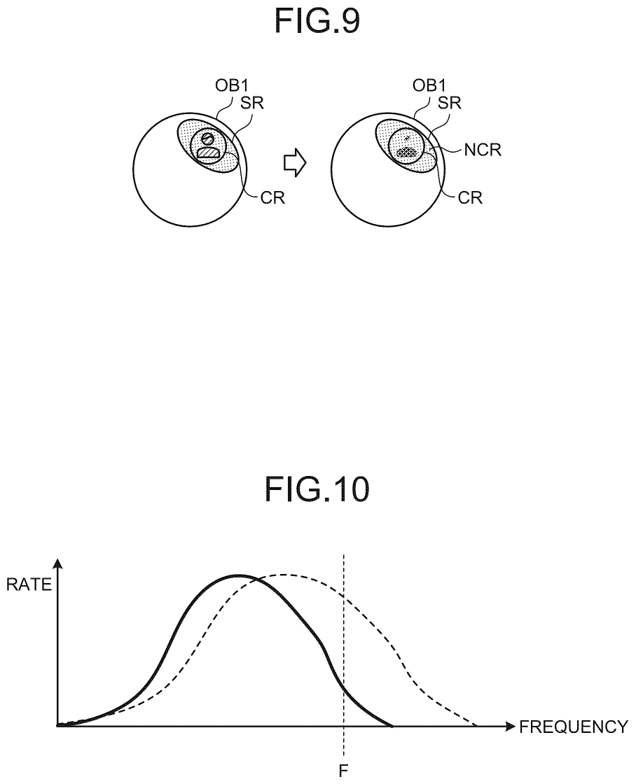

The method determining unit 1351 can determine, for example, low-pass filter processing as the correction method. FIGS. 9 and 10 are a diagram and a graph for explaining an example of the reflected image correction by the low-pass filter processing according to the embodiment of the disclosure.

In a case where the method determining unit 1351 determines the low-pass filter processing as the correction method, the correction processing unit 135 executes the low-pass filter processing on the correction region CR and outputs the corrected specular image (hereinafter, also referred to as a corrected specular image).

As a result, for example, as illustrated in the left diagram of FIG. 9, the correction processing unit 135 can correct the reflected image clearly reflected in the specular reflection region SR of the subject OB1 to a blurred image as illustrated in the right diagram of FIG. 9.

At this point, the correction processing unit 135 generates a corrected specular image in which a high-frequency component in the correction region CR is smaller than a high-frequency component in a region other than the correction region CR (region NCR in FIG. 9, hereinafter also referred to as a non-correction region NCR), for example, by executing low-pass filter processing. Such a point will be described by referring to FIG. 10. Note that the non-correction region NCR is a region obtained by excluding the correction region CR from the specular reflection region SR.

A solid line in FIG. 10 indicates the frequency spectrum of the correction region CR after correction, and a dotted line indicates the frequency spectrum of the non-correction region NCR.

With the correction processing unit 135 executing the low-pass filter processing, the high-frequency components in the correction region CR are cut off. For example, in FIG. 10, frequency components equal to or higher than a frequency F are cut off. Therefore, a first ratio of specific frequency components (frequency components equal to or higher than the frequency F in FIG. 10) in the frequency components of the corrected correction region CR is smaller than a second ratio of the specific frequency components in the frequency components of the non-correction region NCR.

Note that, in this example, the method determining unit 1351 determines the low-pass filter processing as the correction processing executed by the correction processing unit 135; however, it is not limited thereto. For example, the method determining unit 1351 can determine filtering processing of reducing specific frequency components as the correction processing,

### (Pixelation Processing)

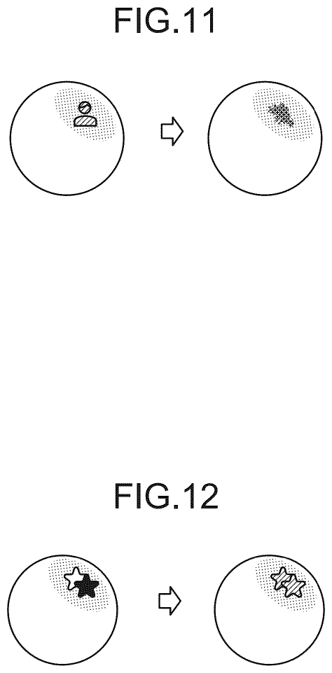

FIG. 11 is a diagram for explaining an example of reflected image correction by pixelation processing according to the embodiment of the disclosure.

In a case where the method determining unit 1351 determines pixelation processing as the correction method, the correction processing unit 135 executes the pixelation processing on the correction region CR and outputs the corrected specular image.

As a result, for example, as illustrated in the left diagram of FIG. 11, the correction processing unit 135 can correct the reflected image clearly reflected in the specular reflection region SR of the subject OB1 to a pixelated blurred image as illustrated in the right diagram of FIG. 11.

### (Saturation Suppression Processing)

FIG. 12 is a diagram for explaining an example of reflected image correction by saturation suppression processing according to the embodiment of the disclosure.

In a case where the method determining unit 1351 determines the saturation suppression processing as the correction method, the correction processing unit 135 executes the saturation suppression processing on the correction region CR and outputs the corrected specular image in which the saturation of the correction region CR is reduced.

As a result, for example, as illustrated in the left diagram of FIG. 12, the correction processing unit 135 can correct reflected images with high saturation reflected in the specular reflection region SR of the subject OB1 to images with low saturation as illustrated in the right diagram of FIG. 12.

### (Intensity Determining Unit 1352)

Returning to FIG. 8, the intensity determining unit 1352 determines the intensity of correction in a case where the correction processing is performed by a correction method determined by the method determining unit 1351. For example, the intensity determining unit 1352 determines the intensity of correction depending on the state of the correction region CR.

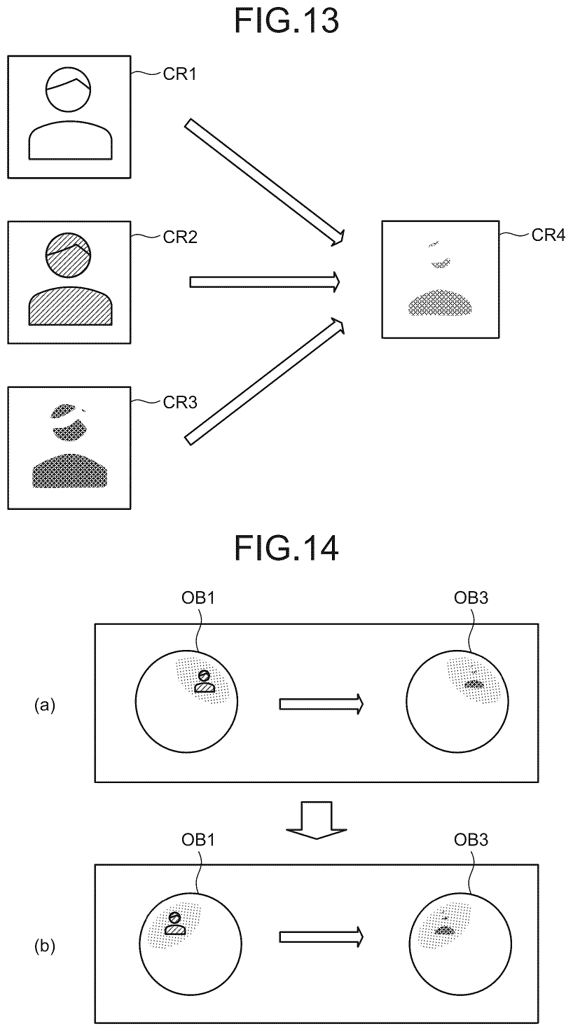

FIG. 13 is a diagram for explaining an example of intensity determined by the intensity determining unit 1352 according to the embodiment of the disclosure.

For example, as illustrated in the right diagram of FIG. 13, it is based on the premise that the state (for example, definition (sharpness)) of an image reflected in a corrected correction region CR4 is defined in advance. The intensity determining unit 1352 determines the intensity of correction depending on the state of the image reflected in the correction region CR (for example, definition) and the state of the image reflected in the correction region CR4 after correction (for example, definition). In other words, the intensity determining unit 1352 determines the intensity of correction at which the image reflected in the correction region CR4 after correction is in a predetermined state.

For example, it is based on the premise that the definition of the reflected image in a correction region CR1 illustrated in the upper left diagram of FIG. 13 is the highest and that the definition of the reflected image in a correction region CR3 illustrated in the lower left diagram is the lowest. It is further based on the premise that the definition of the reflected image in a correction region CR2 illustrated in the middle left diagram is lower than the definition of the correction region CR1 and higher than the definition of the correction region CR3.

In this case, the intensity determining unit 1352 determines the intensity of correction such that the intensity of correction of the correction region CR1 is the highest and that the intensity of correction of the correction region CR3 is the lowest. In addition, the intensity determining unit 1352 determines the intensity of correction such that the intensity of correction of the Correction region CR2 is weaker than that of the correction region CR1 and is stronger than that of the correction region CR3.

Specifically, the intensity determining unit 1352 changes the filter size of the low-pass filter processing depending on the definition of the correction region CR. For example, the intensity determining unit 1352 increases the filter size as the reflected image region R included in the correction region CR is clearer.

As described above, the intensity determining unit 1352 determines the correction intensity of the correction region CR such that the definition of the correction region CR3 after the correction is substantially constant regardless of the definition of the correction region CR before the correction. As a result, the image processing device 100 can output the corrected image in which the definition of the corrected correction region CR4 is substantially constant regardless of the definition of the correction region CR.

Note that, in FIG. 13, the case where the correction processing unit 135 performs the low-pass filter processing has been described; however, it is not limited thereto. The intensity determining unit 1352 is only required to determine the correction intensity depending on the state of the correction region CR before the correction such that the state of the correction region CR4 after the correction becomes a target state.

For example, in a case where the correction processing unit 135 performs pixelation processing, the intensity determining unit 1352 determines the intensity of correction by changing the range of pixelation disposition depending on the definition. For example, the intensity determining unit 1352 widens the range of random disposition as the correction region CR before correction is clearer.

Furthermore, for example, in a case where the correction processing unit 135 performs the saturation suppression processing, the intensity determining unit 1352 changes how to lower the saturation depending on the variance of the saturation in the correction region CR. For example, the intensity determining unit 1352 determines the intensity such that the larger the variance of the saturation of the correction region CR is, the lower the saturation is.

Returning to FIG. 8, the intensity determining unit 1352 outputs the determined intensity to the image correction unit 1353.

### (Image Correction Unit 1353)

The image correction unit 1353 illustrated in FIG. 8 corrects the correction region CR of the specular image with the intensity determined by the intensity determining unit 1352 using the correction method determined by the method determining unit 1351 to generate a corrected specular image. The image correction unit 1553 outputs the corrected specular image to the corrected image generating unit 136.

FIG. 14 is a diagram for describing an example of correction by the image correction unit 1353 according to the embodiment of the disclosure. Illustrated in FIG. 14 is a case where the image correction unit 1353 performs the reflected image correction on a moving image. The left diagram in FIG. 14(a) illustrates an image obtained by the sensor 200 capturing the subject OB1 from a predetermined direction at time T1. Meanwhile, the left diagram in FIG. 14(b) illustrates an image obtained by the sensor 200 capturing the subject OB1 at time T2 after the time T1 from a direction different from that at the time T1. Illustrated in FIG. 14 is an example of processing of the image correction unit 1353 in a case where, for example, the sensor 200 images the subject OB1 while moving from the time T1 to the time T2.

As illustrated in the right diagram of FIG. 14(a), the image correction unit 1353 performs the reflected image correction processing on the image captured by the sensor 200 at the time T1 and generates a corrected specular image including the subject OB3 after correction. Then, as illustrated in the right diagram of FIG. 14(b), the image correction unit 1353 performs the reflected image correction processing on the image captured by the sensor 200 at the time T2 and generates a corrected specular image including the subject OB3 after correction.

As described above, the image correction unit 1353 of the image processing device 100 can perform the reflected image correction following the motion of the subject OB1, for example. In this manner, the image processing device 100 can perform the reflected image correction of a moving image, for example.

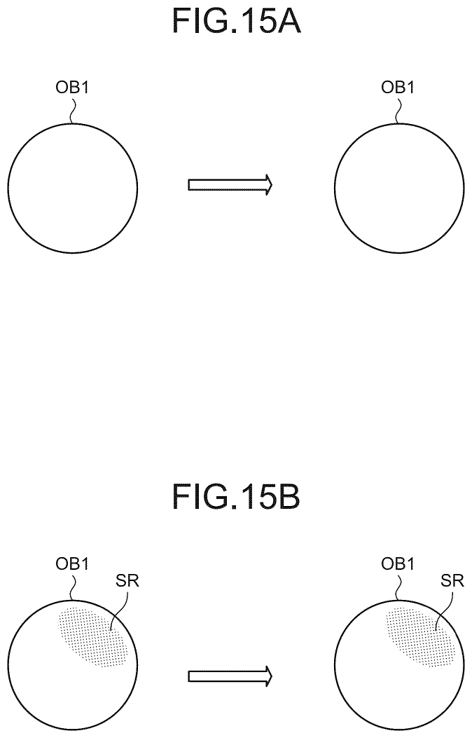

FIGS. 15A and 15B are diagrams for explaining another example of correction by the image correction unit 1353 according to the embodiment of the disclosure.

As illustrated in the left diagram of FIG. 15A, it is based on the premise that no specular reflection region SR is included in the subject OB1. In this case, the image correction unit 1353 does not perform the reflected image correction on the subject OB1 and outputs the subject OB1 as it is as illustrated in the right diagram of FIG. 15A.

Meanwhile, as illustrated in the left diagram of FIG. 15B, let us presume that the subject OB1 includes the specular reflection region SR; however, no image is reflected in the specular reflection region SR. In this case, the image correction unit 1353 outputs the subject OB1 as it is without performing the reflected image correction on the subject OB1 as illustrated in the right diagram of FIG. 15B.

As described above, the image correction unit 1353 of the image processing device 100 performs correction of the correction region CR including the image in a case where an image is reflected in the subject OB1 and does not perform correction in a case where no image is reflected in the subject OB1. This makes it possible to prevent the image processing device 100 from performing unnecessary correction on the subject OB1 on which no image is reflected, thereby enabling to maintain the texture of the subject OB1 on which no image is reflected.

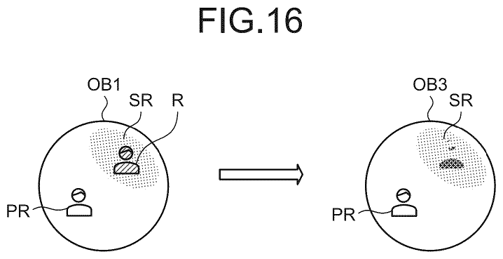

FIG. 16 is a diagram for describing another example of correction by the image correction unit 1353 according to the embodiment of the disclosure.

As illustrated in the left diagram of FIG. 16, it is based on the premise that an image PR is included in a region other than the specular reflection region SR of the subject OB1. The example of the left diagram in FIG. 16 illustrates a case where a drawing of a person (an example of the image PR) is printed in advance on the subject OB1.

In this case, as illustrated in the right diagram of FIG. 16, the image correction unit 1353 performs the reflected image correction on the reflected image region R included in the specular reflection region SR but does not perform the reflected image correction on the image PR appearing on the subject OB1 (for example, printed) in advance.

As described above, the image correction unit 1353 corrects the correction region CR including the image R reflected in the subject OB1 but does not perform correction on parts other than the correction region CR. Therefore, the image processing device 100 can perform the reflected image correction of the reflected image R while maintaining the texture of the subject OB1.

Note that, in this example, the image correction unit 1353 does not perform the reflected image correction on the image PR appearing in advance in the subject OB1; however, it is not limited thereto. For example, the image correction unit 1353 may perform reflected image correction on the image PR. In this case, the image correction unit 1353 sets the correction intensity for the image PR to be lower than the correction intensity for the correction region CR and performs the reflected image correction.

In this case, for example, the intensity determining unit 1352 in FIG. 8 determines the intensity of the reflected image correction for an image specified by the image position specifying unit 1344 in FIG. 7. At this point, the intensity determining unit 1352 determines the correction region CR and the correction intensity of the image PR such that the correction intensity of the correction region CR included in the specular reflection region SR is stronger than the correction intensity of the image PR of the other regions. The image correction unit 1353 performs the reflected image correction on the correction region CR and the image PR specified by the image position specifying unit 1344 with the intensity determined by the intensity determining unit 1352.

Alternatively, the image correction unit 1353 may perform correction on the image PR in accordance with a user's instruction. For example, in a case where the user instructs to perform correction on the image PR, the image correction unit 1353 performs correction on the image PR, and in a case where the user instructs not to perform correction on the image PR, the image correction unit 1353 does not perform correction on the image PR. In a case where the user instructs to perform correction on the image PR, the image correction unit 1353 may perform correction on the image PR with an intensity instructed by the user.

In any of the examples described above, correction that makes it difficult to detect a reflected image is performed; however, the correction processing by the correction processing unit 135 is not limited thereto. For example, in order to notify the user that there is an image reflected in the specular image, the image correction unit 1353 may perform correction processing of emphasizing the correction region CR. Examples of the correction processing include contrast enhancement processing of enhancing the contrast of the correction region CR, saturation enhancement processing of enhancing saturation, and the like.

### (Corrected Image Generating Unit 136)

Returning to FIG. 2, the corrected image generating unit 136 superimposes the corrected specular image generated by the image correction unit 1353 and the diffused image generated by the diffused image generating unit 133 to generate and output the corrected image M3, which is an output image. For example, the corrected image M3 is an image including the subject OB3 on which the reflected image has been corrected.

For example, the corrected image generating unit 136 can generate the corrected image M3 by weighting and adding the luminance value of at least one of the corrected specular image or the diffused image. The corrected image generating unit 136 can output the generated corrected image M3 to a device as an output stage such as a display device (not illustrated).

### 3. Reflected Image Correction Processing

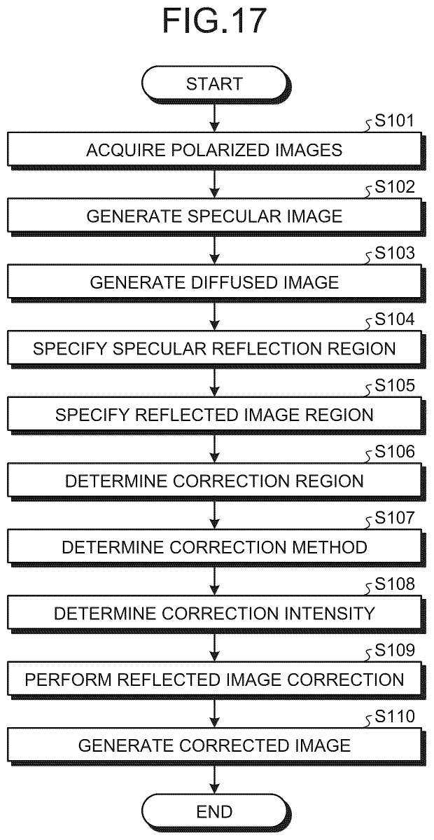

Next, FIG. 17 is a flowchart illustrating an example of a flow of the reflected image correction processing according to the embodiment of the disclosure. The reflected image correction processing illustrated in FIG. 17 is executed by the image processing device 100, For example, in a case where the sensor 200 captures a moving image, the image processing device 100 executes the reflected image correction processing on each frame image (polarized images M2 of each frame) included in the moving image. The image processing device 100 executes the reflected image correction processing while the sensor 200 is performing imaging or in accordance with an instruction from the user.

As illustrated in FIG. 17, the image processing device 100 acquires polarized images M2 from the sensor 200 (step S101). Next, the image processing device 100 generates a specular image on the basis of the polarized images M2 (step S102) and generates a diffused image (step S103).

The image processing device 100 specifies a specular reflection region SR on the basis of the specular image and the diffused image (step S104). The image processing device 100 specifies a reflected image region R included in the specular reflection region SR (step S105). The image processing device 100 determines a correction region CR on the basis of the reflected image region R (step S106).

The image processing device 100 determines a correction method to be performed on the correction region CR (step S107). The image processing device 100 determines the correction intensity of the correction region CR (step S108).

The image processing device 100 performs the reflected image correction on the correction region CR with the correction intensity determined in step S108 using the correction method determined in step S107 (step S109). The image processing device 100 generates a corrected image M3, which is an output image, using the corrected specular image and the diffused image (step S110).

As described above, the image processing device 100 according to the embodiment of the disclosure outputs the corrected image obtained by correcting the correction region CR included in the specular reflection region SR on the basis of the polarized image M2. As a result, the image processing device 100 can correct the reflected image included in the specular reflection region SR while maintaining the texture of the subject OB1.

For example, the reflected image correction processing according to the embodiment of the disclosure can be used for automatically removing (or reducing) a reflected image such as a face or characters included in a photograph or a moving image captured by the sensor 200. As a result, the image processing device 100 can protect privacy of a person whose face, characters, or the like is reflected. Furthermore, with the image processing device 100 automatically executing the reflected image correction processing, it is possible to remove (or mitigate) a reflected image that the user does not aware of, thereby making it possible to protect privacy more reliably.

Furthermore, for example, in the reflected image correction processing according to the embodiment of the disclosure, the user can specify whether or not to execute the reflected image correction or to specify the correction region CR. In this manner, the image processing device 100 can perform at least a part of the reflected image correction processing in accordance with a user's instruction. As a result, the image processing device 100 can remove (or mitigate) reflection of equipment such as the sensor 200, reflection of the photograph-taker, or the like in accordance with the user's intention. Furthermore, the image processing device 100 can selectively remove (or mitigate) a reflected image that the user desires to remove (or mitigate) among all the reflections.

Furthermore, the reflected image correction processing according to the embodiment of the disclosure can be executed for a purpose other than privacy protection. For example, the image processing device 100 can execute the reflected image correction processing in order to execute subsequent processing with higher accuracy. For example, in object detection, the image processing device 100 removes (or mitigates) an object reflected in glass or the like in advance so as not to erroneously detect the reflected image, thereby making it sure to exclude the object from targets of recognition processing for the object detection. As a result, the image processing device 100 can further improve the object detection accuracy. Note that, in this case, the object detection may be performed by the image processing device 100 or may be performed by a device (not illustrated) as an output stage of the image processing device 100.

### 4. Modifications

A part or the entirety of the reflected image correction processing according to the above-described embodiment can be implemented using, for example, artificial intelligence (AI).

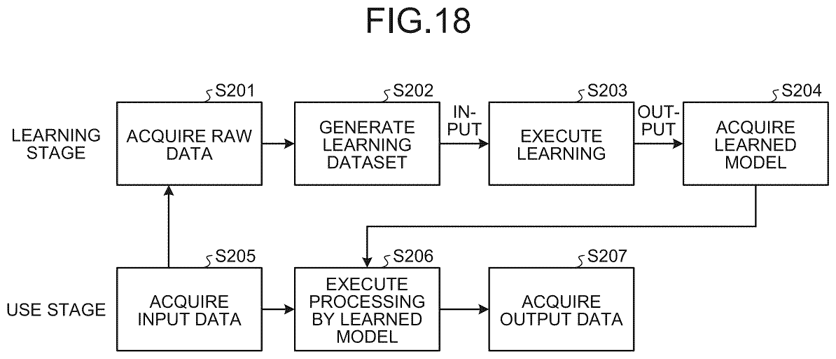

FIG. 18 is a diagram for describing an example of a flow of processing by AI according to the embodiment of the disclosure. The processing (hereinafter, also referred to as AI processing.) by AI is executed by the image processing device 100, for example.

As illustrated in FIG. 18, the image processing device 100 executes the AI processing in two stages of a learning stage and a use stage.

In the learning stage, the image processing device 100 acquires raw data (step S201) and generates a learning dataset (step S202). The raw data is, for example, input data input to a learned model at the use stage. The image processing device 100 generates, for example, a learning dataset obtained by combining the raw data and correct answer data.

Next, the image processing device 100 executes learning using the learning dataset as input (step S203). For example, the image processing device 100 performs supervised machine learning using the learning dataset. As a result, the image processing device 100 acquires the learned model (step S204). The learned model can be generated by using machine learning such as deep neural network (DNN), convolutional neural network (CNN), recurrent neural network (RNN), generative adversarial network (GAN), or an autoencoder, for example.

At the use stage, the image processing device 100 acquires the input data (step S205). The image processing device 100 executes processing by the learned model by inputting the input data to the learned model (step S206) and acquires output data (step S207).

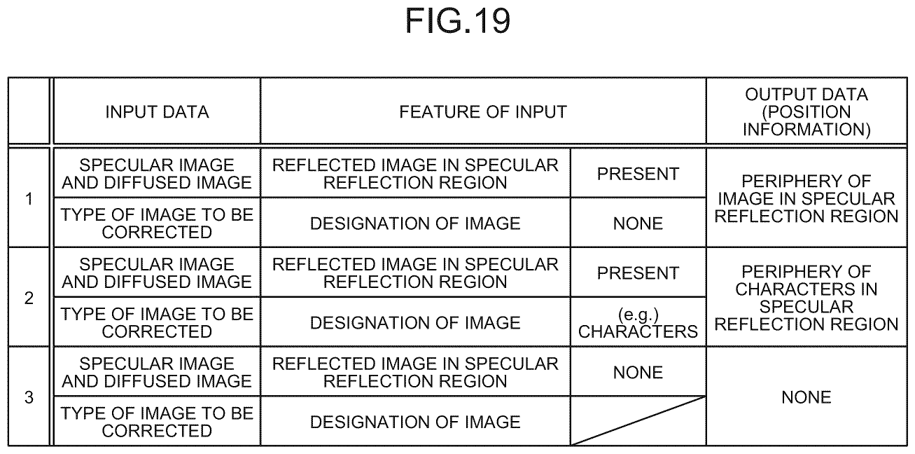

Incidentally, what type of output data is acquired by the image processing device 100 using what type of input data differs depending on which processing of the reflected image correction processing the image processing device 100 executes by AI. Hereinafter, examples of input data and output data will be described as first to third modifications with reference to FIGS. 19 to 32.

### <4.1. First Modification>

As a first modification, it is based on the premise that the image processing device 100 implements processing by the correction region determining unit 134 and processing by the correction processing unit 135 illustrated in FIG. 2 using AI.

In this case, the image processing device 100 learns, for example, a region determination model (an example of the learned model) used by the correction region determining unit 134 to determine the correction region CR. For example, the correction region determining unit 134 determines the correction region CR using the region determination model.

Furthermore, the image processing device 100 learns a correction model (an example of the learned model) used by the correction processing unit 135 for generating a corrected specular image. For example, the correction processing unit 135 generates a corrected specular image using the correction model.

FIG. 19 is a table for describing an example of a region determination model according to the first modification of the embodiment of the disclosure. Illustrated in FIG. 19 is an example of the learning dataset (hereinafter, also referred to as a region determination dataset) for learning the region determination model, for example. Note that, for example, input data corresponds to the raw data in FIG. 18, and output data corresponds to correct answer data in supervised learning.

As illustrated in FIG. 19, the region determination dataset uses, for example, a specular image and a diffused image as input data. At this point, the specular image which is the input data is classified into an image in which an image R is reflected in the specular reflection region SR and an image in which no image R is reflected. In addition, the specular image in which the image R is reflected in the specular reflection region SR is classified into an image in which the reflected image R is designated and an image in which no reflected image R is designated.

The specular image as the input data may include data having a feature that the image R is reflected in the specular reflection region SR and data having a feature that there is no designation for the image R. In this case, the corresponding output data is, for example, information (hereinafter, also referred to as position information) regarding the position around the image R in the specular reflection region SR.

The specular image as the input data may include data having a feature that the image R is reflected in the specular reflection region SR and data having a feature that there is designation for the image R. Incidentally, the designation for the image R means, for example, designation of whether the image R is “characters” or a “person”. Note that illustrated in FIG. 19 is a case where the image R is designated as “characters”, In this case, the corresponding output data is, for example, position information of the periphery of the characters in the specular reflection region SR. Note that, in this case, even in a case where there is a reflected image other than characters in the specular reflection region SR, the position information of the reflected image is not output.

The specular image as the input data may include data having a feature that the image R is not reflected in the specular reflection region SR. In this case, since there is no reflection of the image R, the image R is not designated, and the corresponding output data is “none”.

The image processing device 100 learns the region determination model using, for example, the region determination dataset illustrated in FIG. 19.

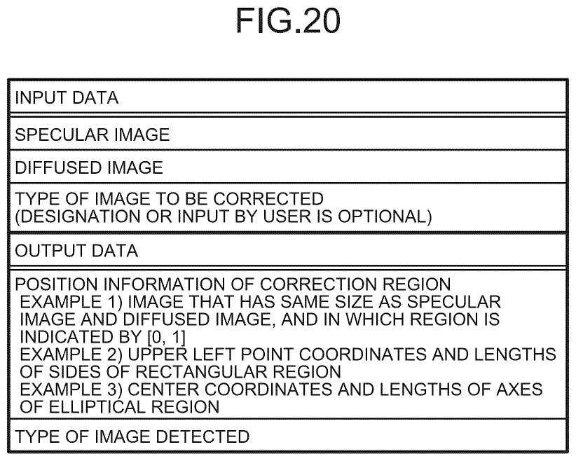

FIG. 20 is a table for explaining an example of the input data and the output data of the region determination model according to the first modification of the embodiment of the disclosure.

As illustrated in FIG. 20, the image processing device 100 uses the specular image and the diffused image as input data of the region determination model. In addition, the image processing device 100 may use the type (for example, “characters”, “person”, and the like) of the image R to be corrected as the input data. The type of the image R to be corrected is designated by the user, for example. Furthermore, whether or not the type of the image R to be corrected is used as input data is optional.

The image processing device 100 acquires position information of the correction region CR as the output data by inputting the input data to the region determination model. The position information of the correction region CR is, for example, a correction region image having pixel values of “0” or “1”. In this case, the correction region image has the same size as those of the specular image and the diffused image, for example, and is an image in which the correction region CR is indicated by pixel values of “1” (or “0”).

Alternatively, the position information of the correction region CR may be information indicated by any position coordinates (for example, upper left point coordinates) and lengths of the sides of a rectangular region. Furthermore, the position information of the correction region CR may be information indicated by any position coordinates (for example, the center coordinates) and lengths of the axes of an elliptical region.

Note that the region determination model may output, as the output data, the type of the detected image R (for example, “characters”, “person”, and the like) in addition to the position information of the correction region CR.

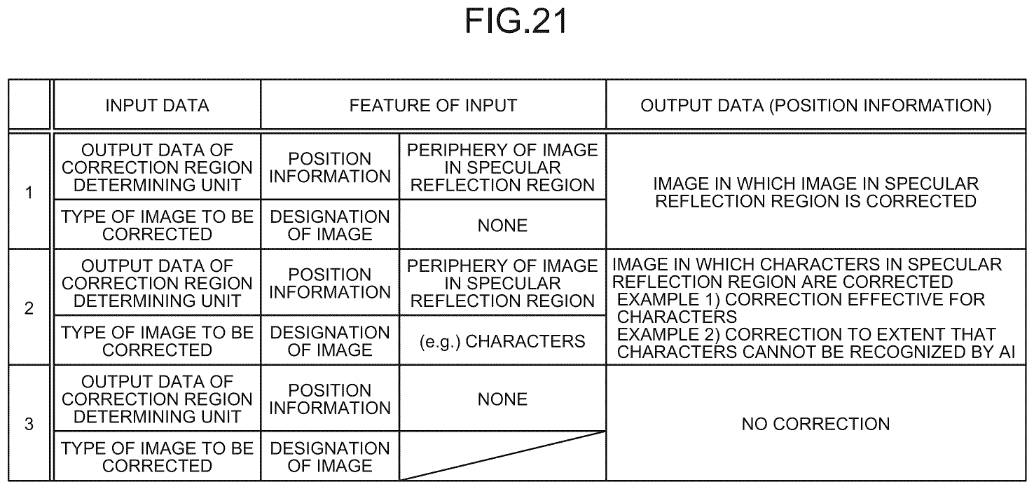

FIG. 21 is a table for explaining an example of a correction model according to the first modification of the embodiment of the disclosure. Illustrated in FIG. 21 is an example of the learning dataset (hereinafter, also referred to as a correction dataset) for learning the correction model, for example. Note that, for example, input data corresponds to the raw data in FIG. 18, and output data corresponds to correct answer data in supervised learning.

As illustrated in FIG. 21, the correction dataset uses, for example, output data of the correction region determining unit 134 as input data. In other words, the correction dataset uses the output data of the region determination model as input data.

At this point, the input data is classified into data having the position information of the correction region CR and data having no position information of the correction region CR. Furthermore, the input data having the position information is classified into data having designation of the image R and data having no designation of the image R.

The input data may include data having a feature that there is position information around the image R in the specular reflection region SR but with no designation of the image R. In this case, the corresponding output data is, for example, an image obtained by correcting the image R in the specular reflection region SR.

The input data may include data having a feature that there is position information around the image R in the specular reflection region SR and that there is designation of the image R. Incidentally, the designation of the image R means, for example, designation of whether the image R is “characters” or a “person”. Note that illustrated in FIG. 21 is a case where the image R is designated as “characters”.

In this case, the corresponding output data is, for example, an image obtained by correcting characters in the specular reflection region SR. At this point, the correction performed on the characters may be, for example, correction (for example, correction to such an extent that it is difficult to recognize that characters are reflected) effective for the characters or correction to an extent that the characters cannot be recognized by AI or the like. Note that, in this case, even in a case where there is a reflected image other than the characters in the specular reflection region SR, the reflected image is not corrected.

The input data may include data having a feature that there is no position information. In this case, the image R is not designated, and the corresponding output data is a specular image (“not corrected”) that is not corrected.

The image processing device 100 learns the correction model using, for example, the correction dataset illustrated in FIG. 21.

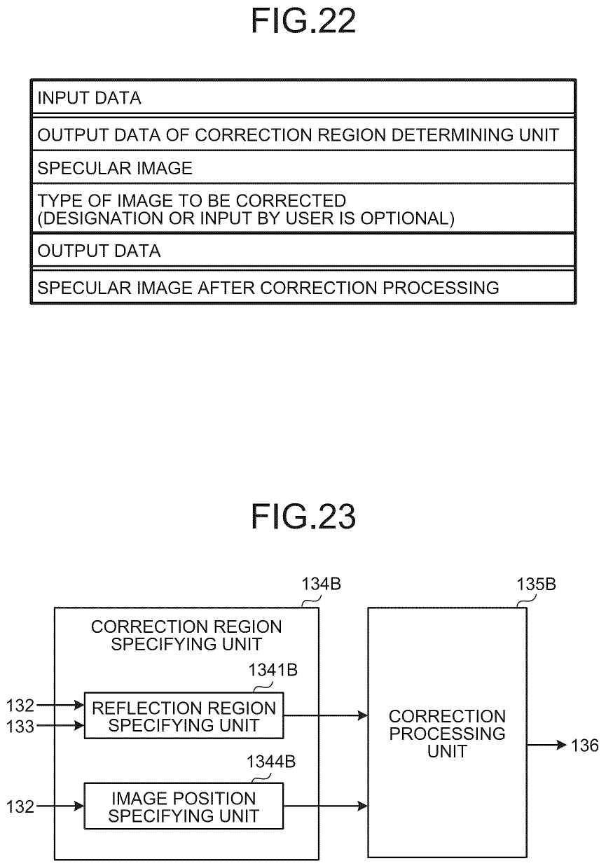

FIG. 22 is a table for explaining an example of input data and output data of the correction model according to the first modification of the embodiment of the disclosure.

As illustrated in FIG. 22, the image processing device 100 uses the output data of the correction region determining unit 134 as input data. In other words, the image processing device 100 uses the output data of the region determination model as input data. In addition, the image processing device 100 may use the type (for example, “characters”, “person”, and the like) of the image R to be corrected as the input data. The type of the image R to be corrected is designated by the user, for example. Alternatively, the type of the image R to be corrected may be output data of the region determination model. Furthermore, whether or not the type of the image R to be corrected is used as input data is optional.

The image processing device 100 inputs the input data to the correction model to acquire the specular image (corrected specular image) after the correction processing as output data.

In this manner, the image processing device 100 can implement the processing by the correction region determining unit 134 and the processing by the correction processing unit 135 illustrated in FIG. 2 using AI.

### <4.2. Second Modification>

FIG. 23 is a block diagram illustrating a configuration example of a correction region determining unit 134B and a correction processing unit 135B according to a second modification of the embodiment of the disclosure. As illustrated in FIG. 23, an image processing device 100 according to the present modification includes the correction region determining unit 134B and the correction processing unit 135B instead of the correction region determining unit 134 and the correction processing unit 135 in FIG. 2. Furthermore, the correction region determining unit 134B illustrated in FIG. 23 includes a reflection region specifying unit 1341B and an image position specifying unit 1344B.

In the present modification, the image processing device 100 implements processing by the reflection region specifying unit 1341B, processing by the image position specifying unit 1344B, and processing by the correction processing unit 135B illustrated in FIG. 23 using AI.

In this case, for example, the image processing device 100 learns a reflection determination model (an example of the learned model) used by the reflection region specifying unit 1341B for determining the specular reflection region SR. For example, the reflection region specifying unit 1341B determines the specular reflection region SR using the reflection determination model.

In addition, the image processing device 100 learns an image specifying model (an example of the learned model) used by the image position specifying unit 1344B to specify an image (object) included in the specular image. For example, the image position specifying unit 1344B specifies an image included in the specular image using the image specifying model.

Furthermore, the image processing device 100 learns a second correction model (an example of the learned model) used by the correction processing unit 135B for generating a corrected specular image. For example, the correction processing unit 135B generates a corrected specular image using the second correction model.

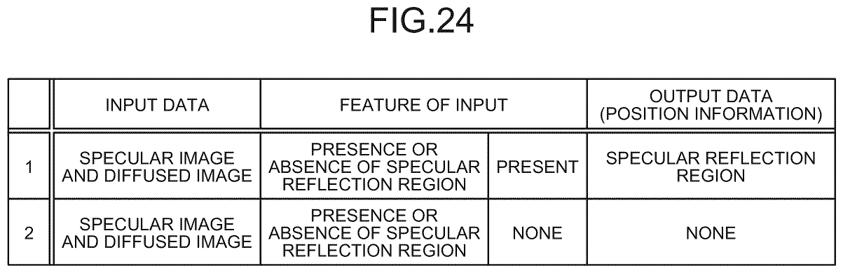

FIG. 24 is a table for explaining an example of a reflection determination model according to the second modification of the embodiment of the disclosure. Illustrated in FIG. 24 is an example of the learning dataset (hereinafter, also referred to as a reflection determination dataset) for learning the reflection determination model, for example. Note that, for example, input data corresponds to the raw data in FIG. 18, and output data corresponds to correct answer data in supervised learning.

As illustrated in FIG. 24, the reflection determination dataset uses, for example, a specular image and a diffused image as input data. At this point, the specular image, which is the input data, is classified into an image having the specular reflection region SR and an image having no specular reflection region SR.

In a case where the specular reflection region SR is included in the specular image of the input data, the corresponding output data is, for example, the position information of the specular reflection region SR in the specular image. In a case where there is no specular reflection region SR in the specular image of the input data, the corresponding output data is “none”.

The image processing device 100 learns the reflection determination model using, for example, the reflection determination dataset illustrated in FIG. 24.

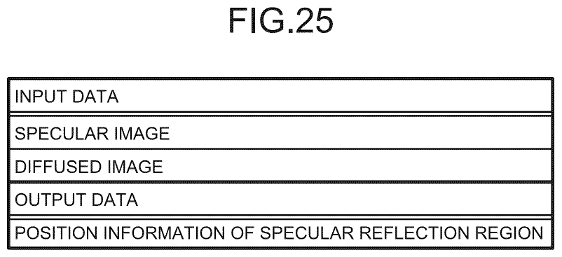

FIG. 25 is a table for explaining an example of input data and output data of a reflection determination model according to the second modification of the embodiment of the disclosure.

As illustrated in FIG. 25, the image processing device 100 uses the specular image and the diffused image as input data of the reflection determination model. The image processing device 100 acquires the position information of the specular reflection region SR as the output data by inputting the input data to the reflection determination model. The position information can be expressed similarly to the position information of the correction region CR described above.

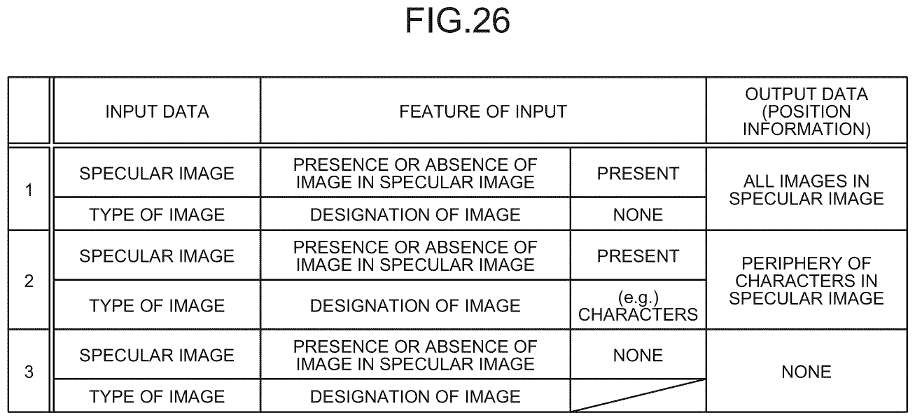

FIG. 26 is a table for explaining an example of an image specifying model according to the second modification of the embodiment of the disclosure. Illustrated in FIG. 26 is an example of the learning dataset (hereinafter, also referred to as an image specifying dataset) for learning the image specifying model, for example. Note that, for example, input data corresponds to the raw data in FIG. 18, and output data corresponds to correct answer data in supervised learning.

As illustrated in FIG. 26, the image specifying dataset uses, for example, a specular image as input data. At this point, the input data is classified into data with an image in the specular image and data with no image in the specular image. In addition, in the case where there is an image in the specular image, further classification is made between data with designation of the image and data with no designation of the image.

The input data may include data having a feature that there is an image in the specular image but with no designation of the image. In this case, the corresponding output data is, for example, position information of all images in the specular image.

The input data may include data having a feature that there is an image in the specular image with designation of the image. Incidentally, the designation of the image means, for example, designation of whether the image is “characters” or a “person”. Note that illustrated in FIG. 26 is the case where the image is designated as “characters”. In this case, the corresponding output data is, for example, position information of the periphery of the characters in the specular image. Note that, in this case, even in a case where there is a reflected image other than characters in the specular reflection region SR, the position information of the reflected image is not output.

The input data may include data having a feature that there is no image in the specular image. In this case, designation of an image is not performed, and the corresponding output data is “none”.

The image processing device 100 learns the image specifying model using, for example, the image specifying dataset illustrated in FIG. 26.

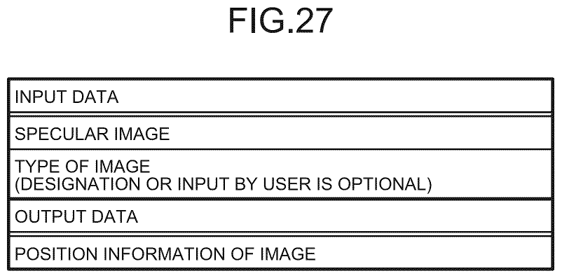

FIG. 27 is a table for explaining an example of input data and output data of the image specifying model according to the second modification of the embodiment of the disclosure.

As illustrated in FIG. 27, the image processing device 100 uses the specular image as input data of the image specifying model. Furthermore, the image processing device 100 may use the type (for example, “characters”, “person”, and the like) of the image in the specular image as input data. The type of the image is designated by the user, for example. Furthermore, whether or not the type of the image is used as input data is optional. The type of the image can be the same as the type of the image R to be corrected.

The image processing device 100 acquires position information of the image in the specular image as output data by inputting the input data to the image specifying model. The position information of the image can be expressed similarly to the position information of the correction region CR described above.

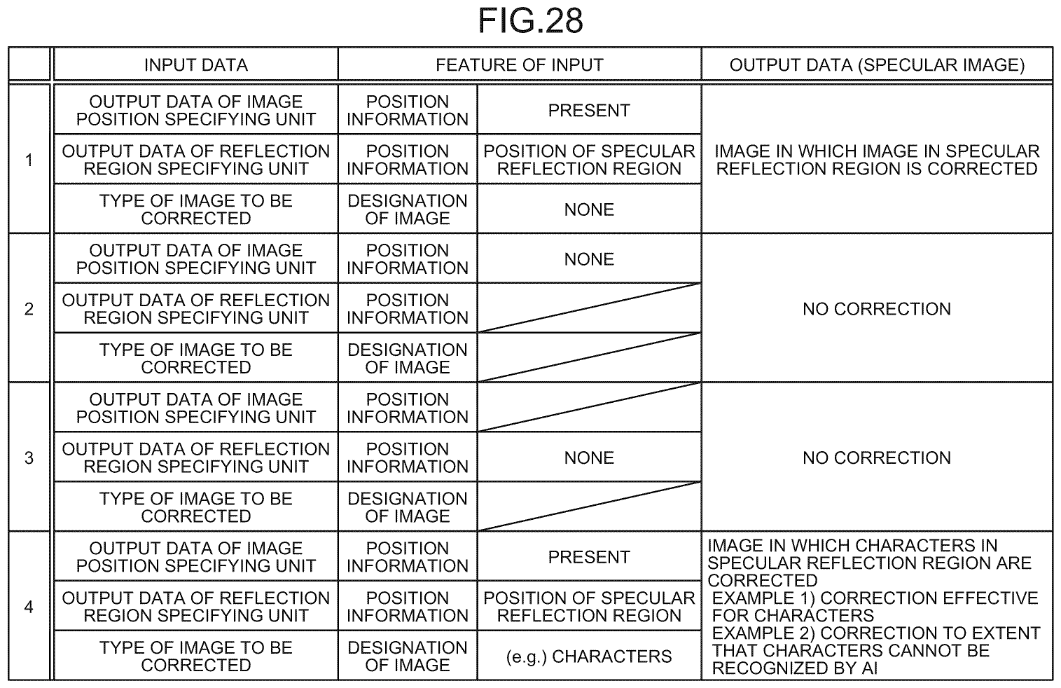

FIG. 28 is a table for explaining an example of a second correction model according to the second modification of the embodiment of the disclosure. Illustrated in FIG. 28 is an example of the learning dataset (hereinafter, also referred to as a second correction dataset) for learning the second correction model, for example. Note that, for example, input data corresponds to the raw data in FIG. 18, and output data corresponds to correct answer data in supervised learning.

As illustrated in FIG. 28, the second correction dataset uses, for example, output data of the image position specifying unit 1344B and the reflection region specifying unit 1341B as input data. In other words, the correction dataset uses the output data of the image specifying model and the reflection determination model as input data.

At this point, the input data is classified into data having the position information of the image and the specular reflection region SR and data having no such position information. In addition, the input data having the position information of the image and the specular reflection region SR is classified into data with designation of the image R and data with no designation of the image R.

The input data can include data having a feature that the output data of the image position specifying unit 1344B includes position information of an image in the specular image and that the output data of the reflection region specifying unit 1341B includes information regarding the position of the specular reflection region SR. In this case, for example, in a case where there is no designation of the image R to be corrected as the input data, the corresponding output data is, for example, an image obtained by correcting the image R in the specular reflection region SR.

Meanwhile, in this case, for example, in a case where there is designation of the image R to be corrected as the input data (for example, designated as “characters”), the corresponding output data is, for example, an image obtained by correcting the characters in the specular reflection region SR. At this point, the correction performed on the characters may be, for example, correction (for example, correction to such an extent that it is difficult to recognize that characters are reflected) effective for the characters or correction to an extent that the characters cannot be recognized by AI or the like. Note that, in this case, even in a case where there is a reflected image other than the characters in the specular reflection region SR, the reflected image is not corrected.

The input data may include data having a feature that the output data of the image position specifying unit 1344B has no position information of the image in the specular image. In this case, regardless of the output data of the reflection region specifying unit 1341B and designation of the image R to be corrected, the corresponding output data is the specular image that is uncorrected. That is, in a case where no image is included in the specular image, the reflected image correction is not executed on the specular image regardless of the presence or absence of the specular reflection region SR.

In addition, the input data may include data having a feature that the output data of the reflection region specifying unit 1341B has no position information of the specular reflection region SR. In this case, regardless of the output data of the image position specifying unit 1344B and designation of the image R to be corrected, the corresponding output data is the specular image that is uncorrected. That is, in a case where no specular reflection region SR is included in the specular image, the reflected image correction is not executed on the specular image regardless of the presence or absence of the image in the specular image.

The image processing device 100 learns the second correction model using, for example, the second correction dataset illustrated in FIG. 28.

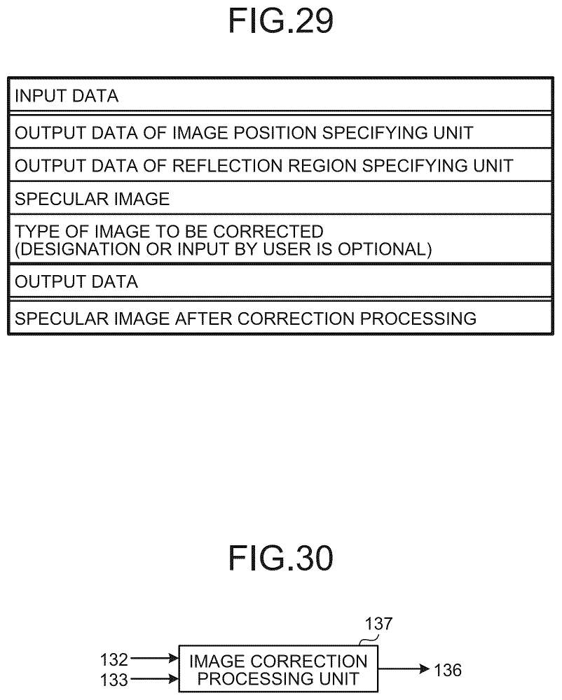

FIG. 29 is a table for explaining an example of input data and output data of the second correction model according to the second modification of the embodiment of the disclosure.

As illustrated in FIG. 29, the image processing device 100 uses output data of the image position specifying unit 1344B and the reflection region specifying unit 1341B as input data. In other words, the correction dataset uses the output data of the image specifying model and the reflection determination model as input data. In addition, the image processing device 100 may use the type (for example, “characters”, “person”, and the like) of the image R to be corrected as the input data. The type of the image R to be corrected is designated by the user, for example. Furthermore, whether or not the type of the image R to be corrected is used as input data is optional.

The image processing device 100 inputs the input data to the second correction model to acquire the specular image (corrected specular image) after the correction processing as output data.

In this manner, the image processing device 100 can implement the processing by the correction region determining unit 134B and the processing by the correction processing unit 135B illustrated in FIG. 23 using AI.

### <4.3. Third Modification>

In the first and second modifications described above, the image processing device 100 executes the processing of the correction region determining units 134 and 134B and the processing of the correction processing units 135 and 135B each using AI; however, it is not limited thereto. For example, the image processing device 100 may implement the processing of the correction region determining unit 134 and the correction processing unit 135 as one piece of processing.

FIG. 30 is a block diagram illustrating an example of an image correction processing unit 137 according to a third modification of the embodiment of the disclosure. As illustrated in FIG. 30, an image processing device 100 includes the image correction processing unit 137 instead of the correction region determining unit 134 and the correction processing unit 135 in FIG. 2.

The image correction processing unit 137 generates a corrected specular image using a specular image generated by the specular image generating unit 132 and a diffused image generated by the diffused image generating unit 133 and outputs the corrected specular image to the corrected image generating unit 136.

In the present modification, it is based on the premise that the image processing device 100 implements processing by the image correction processing unit 137 illustrated in FIG. 30 using AI.

In this case, for example, the image processing device 100 learns a reflected image correction model (an example of a learned model) used by the image correction processing unit 137 for generating the corrected specular image. The image correction processing unit 137 generates the corrected specular image using, for example, a reflected image correction model.

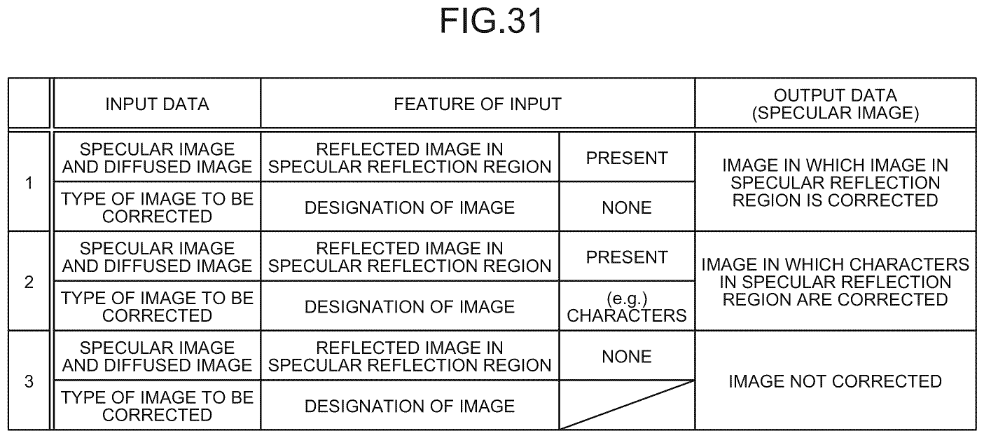

FIG. 31 is a table for explaining an example of the reflected image correction model according to the third modification of the embodiment of the disclosure. Illustrated in FIG. 31 is an example of the learning dataset (hereinafter, also referred to as a reflected image correction dataset) for learning the reflected image correction model, for example. Note that, for example, input data corresponds to the raw data in FIG. 18, and output data corresponds to correct answer data in supervised learning.

As illustrated in FIG. 31, the reflected image correction dataset uses, for example, a specular image and a diffused image as input data. At this point, the specular image which is the input data is classified into an image in which an image R is reflected in the specular reflection region SR and an image in which no image R is reflected. In addition, the specular image in which the image R is reflected in the specular reflection region SR is classified into an image in which the reflected image R is designated and an image in which no reflected image R is designated.

The specular image as the input data may include data having a feature that the image R is reflected in the specular reflection region SR and data having a feature that there is no designation for the image R. In this case, the corresponding output data is, for example, an image obtained by correcting the image R in the specular reflection region SR (corrected specular image).

The specular image as the input data may include data having a feature that the image R is reflected in the specular reflection region SR and data having a feature that there is designation for the image R. Incidentally, the designation of the image R means, for example, designation of whether the image R is “characters” or a “person”. Note that illustrated in FIG. 31 is a case where the image R is designated as “characters”. In this case, the corresponding output data is, for example, an image obtained by correcting the periphery of the characters in the specular reflection region SR (corrected specular image). Note that, in this case, even in a case where there is a reflected image other than the characters in the specular reflection region SR, the reflected image is not corrected.

The specular image as the input data may include data having a feature that the image R is not reflected in the specular reflection region SR. In this case, since there is no reflection of the image R, the image R is not designated, and the corresponding output data is an uncorrected image (specular image).

The image processing device 100 learns the region determination model using, for example, a reflected image correction dataset illustrated in FIG. 31.

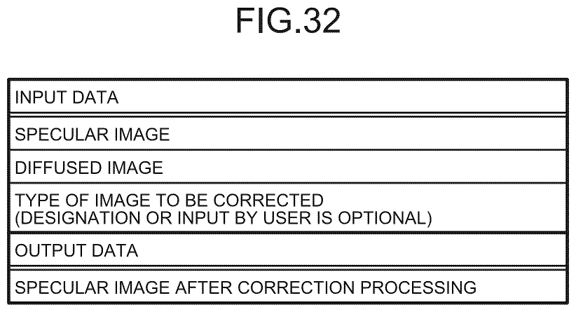

FIG. 32 is a table for explaining an example of input data and output data of a reflected image correction model according to a third modification of the embodiment of the disclosure.

As illustrated in FIG. 32, the image processing device 100 uses the specular image and the diffused image as input data of the reflected image correction model. In addition, the image processing device 100 may use the type (for example, “characters”, “person”, and the like) of the image R to be corrected as the input data. The type of the image R to be corrected is designated by the user, for example. Furthermore, whether or not the type of the image R to be corrected is used as input data is optional.

The image processing device 100 inputs the input data to the reflected image correction model to acquire the specular image (corrected specular image) after the correction processing as output data.

In this example, the image processing device 100 uses the specular image and the diffused image as input and generates the corrected specular image using AI; however, it is not limited thereto. For example, the image processing device 100 may use the specular image and the diffused image as input and generate a corrected image that is an output image using AI. In this case, the image processing device 100 can omit the corrected image generating unit 136 (see FIG. 2).

Alternatively, for example, the image processing device 100 may use the polarized images as input and generate the corrected specular image (or corrected image) using AI. In this case, the image processing device 100 can omit the specular image generating unit 132 and the diffused image generating unit 133 (see FIG. 2).

### 5. Example of Corrected Image

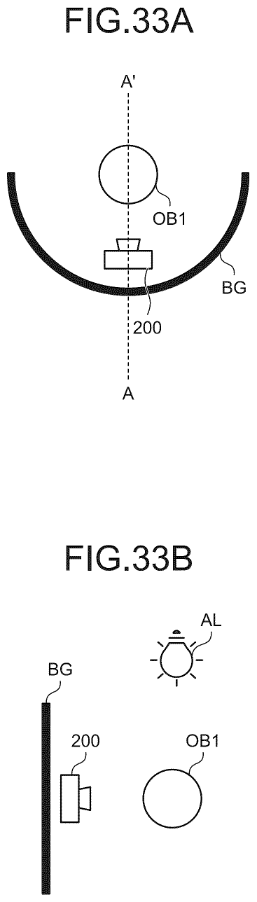

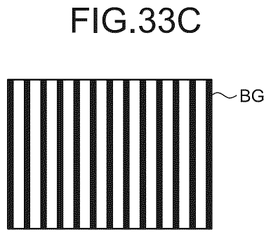

Next, an example of the corrected image output by the image processing system 10 will be described. FIGS. 33A to 33C are diagrams for explaining an example of the imaging environment according to the embodiment of the disclosure, Description is given here on an example of the corrected image output by the image processing device 100 on the basis of polarized images M2 captured by a sensor 200 of the image processing system 10 in the imaging environment illustrated in FIGS. 33A to 33C.

Illustrated in FIG. 33A is a case where the imaging environment in which the sensor 200 performs imaging is viewed from above with respect to the ground (not illustrated). Furthermore, in FIG. 33B, the imaging environment in A-A′ of FIG. 33A is illustrated. As illustrated in FIGS. 33A and 33B, the sensor 200 is located inside a semi-cylindrical background BG and captures an image of a spherical subject OB1 arranged substantially at the center of the background BG. Furthermore, ambient light AL is disposed in the imaging environment. In FIG. 33B, illustrated is a case where the ambient light AL is a predetermined light source such as a fluorescent light. In this example, the ambient light AL is unpolarized light or a light source having a low polarization degree.

As illustrated in FIG. 33C, the background BG has a stripe pattern in which white and black straight lines are alternately arranged. The subject OB1 has, for example, a highly glossy surface and has a surface shape that reflects reflection light from the background BG toward the sensor 200.

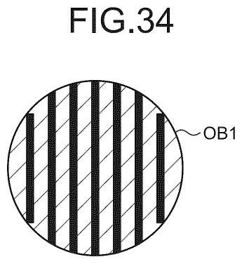

FIG. 34 is a diagram illustrating an example of an image output by the image processing system 10 according to the embodiment of the disclosure. Note that it is based on the premise that reflection of the background BG is not corrected in this example. In the imaging environment illustrated in FIGS. 33A to 33C, since there is no reflection other than that of the background BG, the image processing system 10 outputs an image including the subject OB1 in which the background BG is reflected as illustrated in FIG. 34.

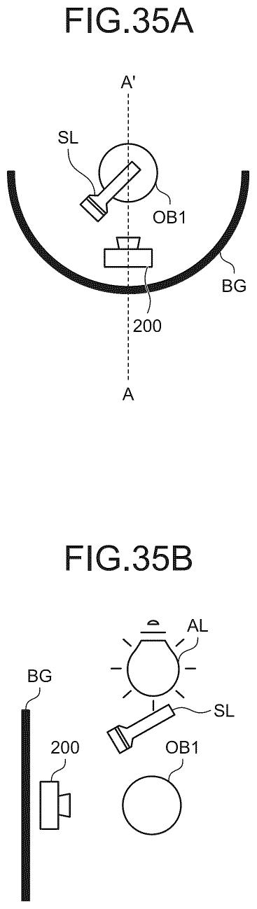

FIGS. 35A and 35B are diagrams for explaining another example of the imaging environment according to the embodiment of the disclosure. The imaging environment illustrated in FIGS. 35A and 35B is the same as that in FIGS. 33A to 33C except that a spotlight SL is disposed. In this example, it is based on the premise that the spotlight SL is a polarized light source and has a polarization degree higher than that of the ambient light AL.

As illustrated in FIGS. 35A and 35B, the spotlight SL is disposed in such a manner as to emit light from the upper right of the camera to the right in the imaging environment. In this case, the background BG hit by the light of the spotlight SL is reflected in a specific region of the subject OB1.

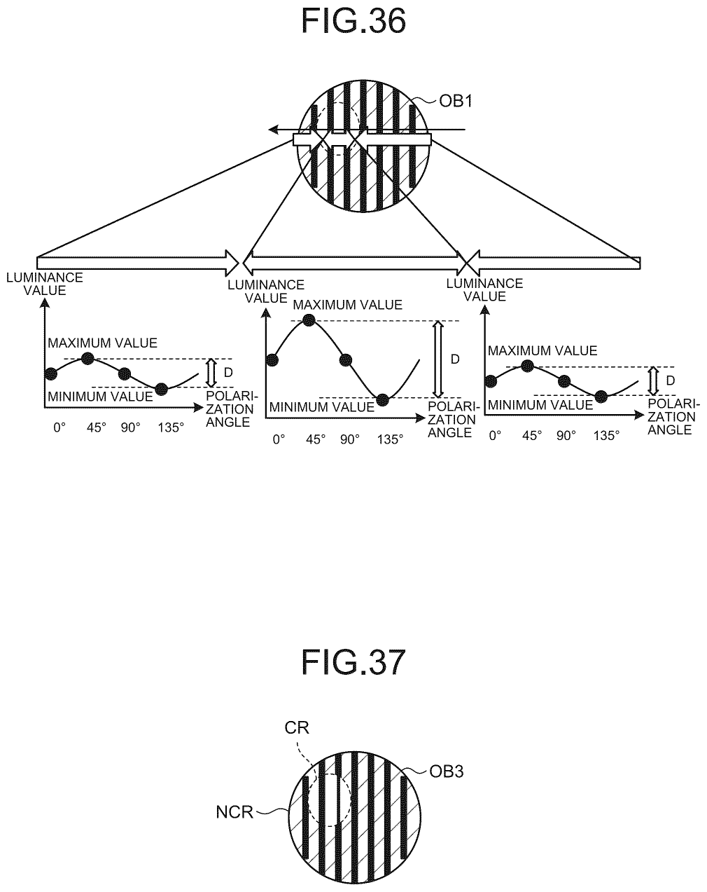

FIG. 36 is a diagram for explaining reflected image correction performed by the image processing system 10 according to the embodiment of the disclosure.

The image processing system 10 acquires an image including the subject OB1 in which the light of the spotlight SL is reflected as illustrated in the upper diagram of FIG. 36. The image processing system 10 acquires, for example, a plurality of polarized images having different polarization angles (in the example of FIG. 36, 0°, 45°, 90°, and 135°). As described above, the luminance values of the same pixels of the polarized images are approximated as a trigonometric function having the polarization angle as a variable.

For example, the image processing system 10 generates a specular image by using a difference D between the maximum value and the minimum value of the luminance values approximated as the trigonometric function as a luminance value of each image. In addition, the image processing system 10 generates a diffused image using, for example, the minimum value of luminance values approximated as the trigonometric function as a luminance value of each image.

Incidentally, as illustrated in the lower diagram of FIG. 36, the difference D in a first region in which the spotlight SL is reflected is larger than, for example, the difference D in a second region other than the first region.

The image processing system 10 performs reflected image correction using the first region in which the spotlight SL is reflected as the correction region CR. For example, the image processing system 10 applies low-pass filter processing to the correction region CR.

On the other hand, the image processing system 10 sets the second region where the spotlight SL is not reflected as a non-correction region NCR that is not to be corrected. For example, the image processing system 10 does not apply the low-pass filter processing to the non-correction region NCR.

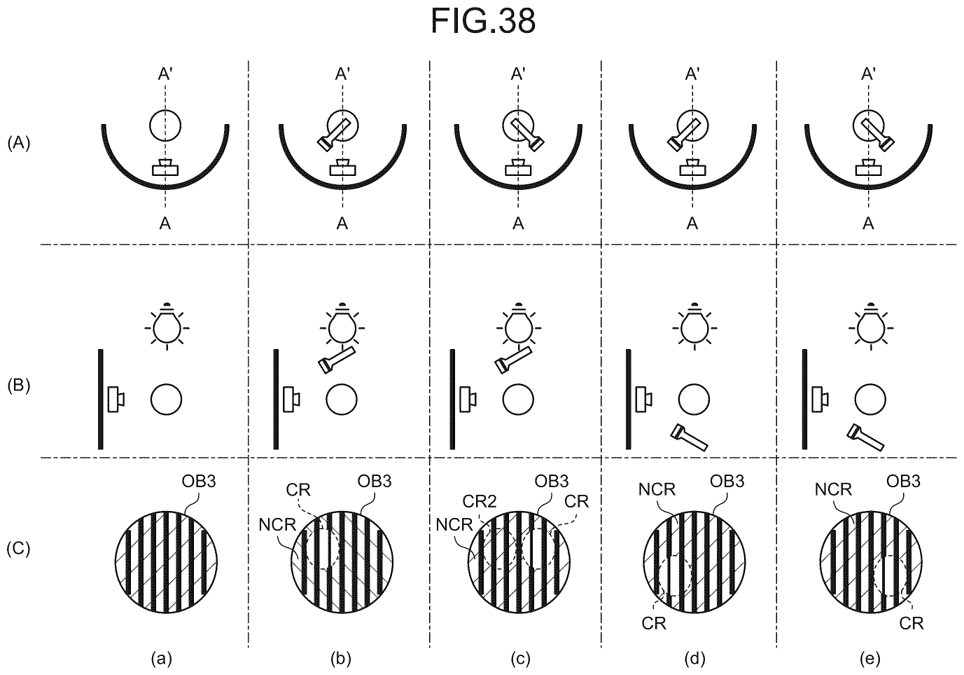

FIG. 37 is a diagram illustrating another example of the image output by the image processing system 10 according to the embodiment of the disclosure. Note that, in this example, as described above, it is based on the premise that the image processing system 10 does not correct the reflection of the background BG.

As described above, light of the spotlight SL reflected by the background BG is reflected on the subject OB1 in addition to the background BG. As illustrated in FIG. 37, the image processing system 10 outputs a corrected image including the subject OB3 in which the reflection of the light of the spotlight SL has been corrected.

The subject OB3 illustrated in FIG. 37 includes the correction region CR and the non-correction region NCR. The correction region CR is a specific region subjected to the reflected image correction processing. Meanwhile, the non-correction region NCR is a region where reflected image correction is not performed. Incidentally, it is based on the premise that the image processing system 10 performs, for example, low-pass filter processing as the reflected image correction processing.

In this case, in the correction region CR, the amount of high-frequency components of the stripe pattern is smaller than that in the non-correction region NCR.

As described above, the image processing system 10 outputs the corrected image in which the amount of the specific frequency components in the correction region CR is smaller than that of the specific frequency components in the non-correction region NCR.

In FIGS. 35A and 35B, the spotlight SL is disposed to be directed from the upper right to the lower left; however, the disposition of the spotlight SL is not limited thereto. This point will be described by referring to FIG. 38.

FIG. 38 is a diagram for explaining another example of the corrected image according to the embodiment of the disclosure. FIG. 38(A) is a diagram illustrating a case where the imaging environment is viewed from above, FIG. 38(B) is a diagram illustrating the imaging environment along A-A′. FIG. 38(C) is a diagram illustrating the image output by the image processing system 10.

FIG. 38(a) is a diagram illustrating a case where the spotlight SL is not disposed. FIG. 38(b) is a diagram illustrating a case where the spotlight SL is disposed to be directed from the upper right of the camera to the right. FIG. 38(c) is a diagram illustrating a case where the spotlight SL is disposed to be directed from the upper left to the left.

FIG. 38(d) is a diagram illustrating a case where the spotlight SL is disposed to be directed from the lower right of the camera to the right. FIG. 38(e) is a diagram illustrating a case where the spotlight SL is disposed to be directed from the lower left to the left.

As illustrated in (a) of FIG. 38(C), in a case where there is no spotlight SL and the light source is the ambient light AL, as described above, the image processing system 10 outputs an image including the subject OB1 without performing the reflected image correction.

Meanwhile, as illustrated in (b) to (e) of FIG. 38(C), in the cases where the spotlight SL is disposed in the imaging environment, the image processing system 10 outputs a corrected image including the subject OB3 on which the reflected image correction has been performed.

The correction region CR of the subject OB3 is a region in which the spotlight SL is reflected. In the correction region CR, the amount of high-frequency components of the stripe pattern is smaller than that in the non-correction region NCR in which the spotlight SL is not reflected. That is, the ratio of the high frequency components in the frequency components in the correction region CR is smaller than the ratio of the high frequency components in the frequency components in the non-correction region NCR.

For example, the ratio of the high frequency components in the frequency components in the non-correction region NCR is substantially the same as the ratio of the high frequency components in the frequency components in the subject OB3 of a case where the spotlight SL is not included.

In addition, for example, let us assume that the disposition of the spotlight SL is moved from FIG. 38(b) to FIG. 38(c). In this case, the position of the correction region CR also moves from the upper right to the upper left of the subject OB3. At this point, in the correction region CR (region CR2 in FIG. 38(c)) in which the spotlight SL is reflected and the ratio of the high frequency components is low in FIG. 38(b), the ratio of the high frequency components increases to the same extent as that of the non-correction region NCR in FIG. 38(c).

As described above, the image processing system 10 outputs the corrected image in which the amount of the high-frequency components of the stripe pattern is reduced in the correction region CR in which the spotlight SL is reflected than in the non-correction region NCR. Note that the high frequency components can be determined, for example, depending on the cut frequency in the low-pass filter processing.

Note that, although the case where the image processing system 10 selects the low-pass filter processing as the reflected image correction processing has been described here, it is not limited thereto. As described above, the image processing system 10 can select pixelation processing or saturation suppression processing as the reflected image correction processing other than the low-pass filter processing.

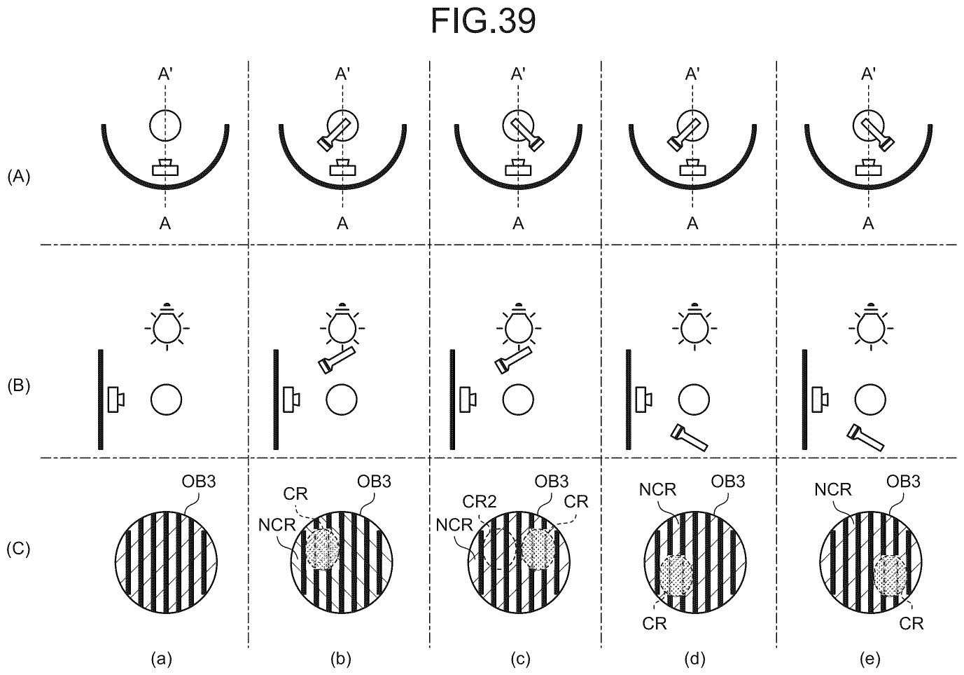

FIG. 39 is a diagram for explaining another example of the corrected image according to the embodiment of the disclosure. In this example, the case where the image processing system 10 performs pixelation processing is illustrated. FIG. 39 is the same as the diagram illustrated in FIG. 38 except that illustrated in FIG. 39(C) is the corrected image after pixelation processing.

As illustrated in (a) of FIG. 39(C), in a case where there is no spotlight SL and the light source is the ambient light AL, as described above, the image processing system 10 outputs an image including the subject OB1 without performing the reflected image correction.

Meanwhile, as illustrated in (b) to (e) of FIG. 39(C), in the cases where the spotlight SL is disposed in the imaging environment, the image processing system 10 outputs a corrected image including the subject OB3 on which pixelation processing has been performed as reflected image correction.

The correction region CR of the subject OB3 is a region in which the spotlight SL is reflected. The correction region CR is pixelated. On the other hand, the non-correction region NCR is not pixelated and has an image with the same stripe pattern as the case where the reflected image correction is not performed.

In addition, for example, let us assume that the disposition of the spotlight SL is moved from FIG. 39(b) to FIG. 39(c). In this case, the position of the correction region CR also moves from the upper right to the upper left of the subject OB3. At this point, the correction region CR (region CR2 in FIG. 39(c)) in which the spotlight SL is reflected and pixelated in FIG. 39(b) also has the same stripe pattern as that in the case where the reflected image correction is not performed in FIG. 39(c).

As described above, the image processing system 10 outputs a corrected image in which the correction region CR is pixelated in which the spotlight SL is reflected and the non-correction region NCR is not pixelated.

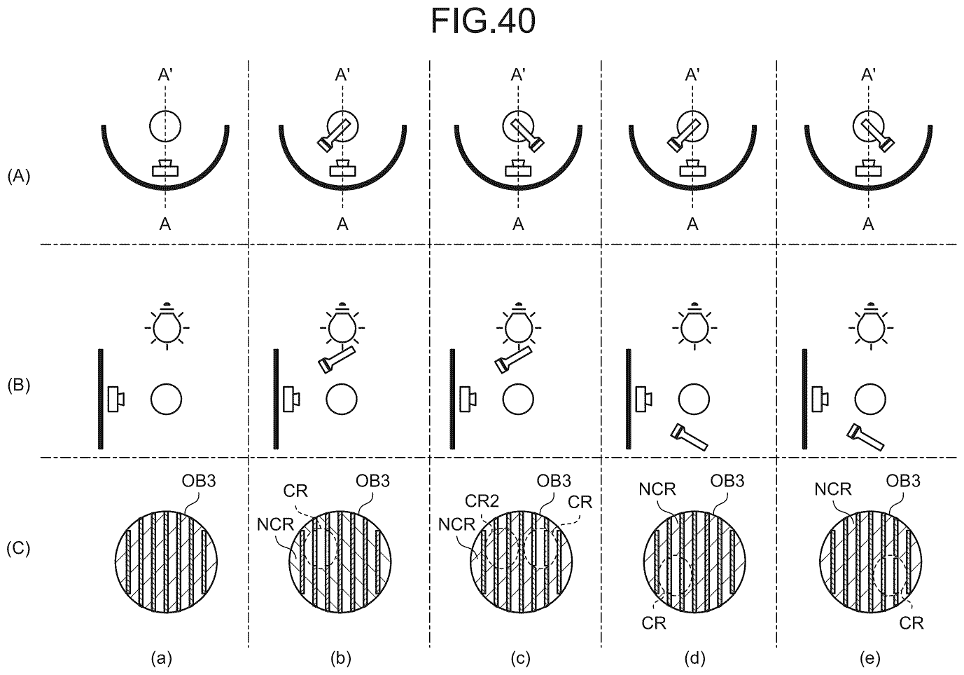

FIG. 40 is a diagram for explaining another example of the corrected image according to the embodiment of the disclosure. In this example, the case where the image processing system 10 performs saturation suppression processing is illustrated. FIG. 40 is the same as the diagram illustrated in FIG. 38 except that the corrected image after the saturation suppression processing is illustrated in FIG. 40(C) and that the background BG is a colored stripe pattern.

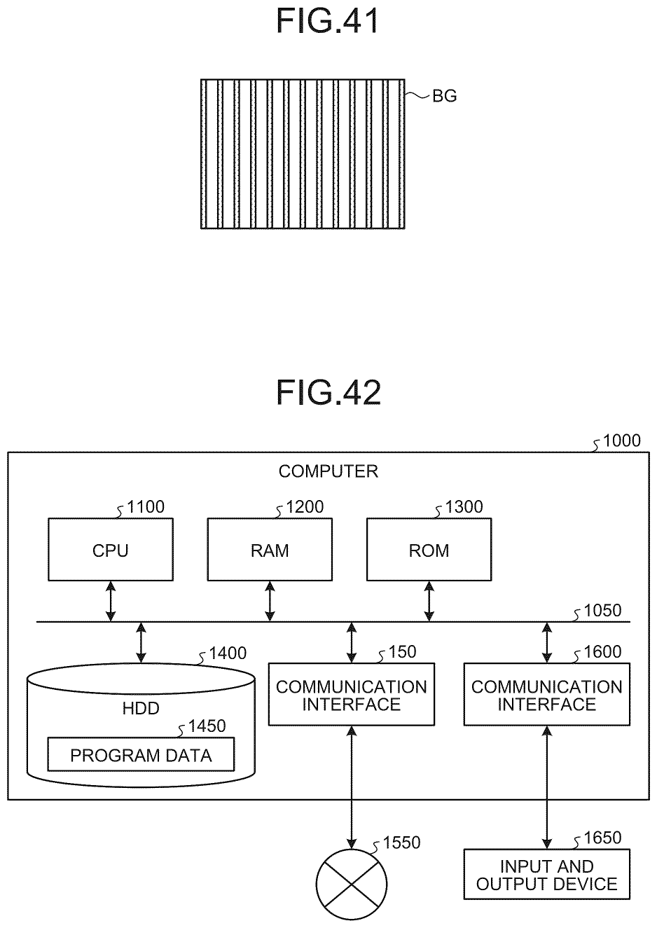

FIG. 41 is a diagram illustrating an example of the background BG according to the embodiment of the disclosure. As illustrated in FIG. 41, the background BG here has a colored stripe pattern in which straight lines of white and a predetermined color (for example, blue) are alternately arranged.

Returning to FIG. 40, as illustrated in (a) of FIG. 40(C), in a case where there is no spotlight SL and the light source is the ambient light AL, as described above, the image processing system 10 outputs an image including the subject OB1 without performing the reflected image correction.

Meanwhile, as illustrated in (b) to (e) of FIG. 40(C), in the cases where the spotlight SL is disposed in the imaging environment, the image processing system 10 outputs a corrected image including the subject OB3 on which saturation suppression processing has been performed as the reflected image correction.

The correction region CR of the subject OB3 is a region in which the spotlight SL is reflected. In the correction region CR, the saturation of the colored stripe pattern is low. On the other hand, the non-correction region NCR has an image having the same saturation as that of the case where the saturation suppression processing is not applied and the reflected image correction is not performed.

In addition, for example, let us assume that the disposition of the spotlight SL is moved from FIG. 40(b) to FIG. 40(c). In this case, the position of the correction region CR also moves from the upper right to the upper left of the subject OB3. At this point, the correction region CR (region CR2 in FIG. 40(c)) in which the spotlight SL is reflected and saturation is reduced in FIG. 40(b) also has the stripe pattern of the same saturation as that in the case where the reflected image correction is not performed in FIG. 40(c).

As described above, the image processing system 10 outputs the corrected image in which the saturation of the correction region CR in which the spotlight SL is reflected is lower than the saturation of the non-correction region NCR.

### 6. Other Embodiments

The above embodiments and modifications are examples, and various modifications and applications can be made.

For example, an image processing program for executing the above actions is stored and distributed in a computer-readable recording medium such as an optical disc, a semiconductor memory, a magnetic tape, or a flexible disk. Moreover, for example, the control device is configured by installing the program in a computer and executing the above processing. At this point, the control device may be a device (for example, a personal computer) external to the image processing device 100. Furthermore, the control device may be a device (for example, the control unit 130) inside the image processing device 100.

In addition, the image processing program may be stored in a disk device included in a server device on a network such as the Internet such that the image processing program can be downloaded to a computer. In addition, the above functions may be implemented by collaborative operation between an operating system (OS) and application software. In this case, a portion other than the OS may be stored in a medium and distributed, or a portion other than the OS may be stored in a server device to allow a computer to download it, for example.

Among the pieces of processing described in the above embodiments, all or a part of processing described as that performed automatically can be performed manually, or all or a part of processing described as that performed manually can be performed automatically by a known method. In addition, a processing procedure, a specific name, and information including various types of data or parameters illustrated in the above or in the drawings can be modified as desired unless otherwise specified. For example, various types of information illustrated in the drawings are not limited to the information illustrated.

In addition, each component of each device illustrated in the drawings is conceptual in terms of function and is not necessarily physically configured as illustrated in the drawings. That is, the specific form of distribution and integration of devices is not limited to those illustrated in the drawings, and all or a part thereof can be functionally or physically distributed or integrated in any unit depending on various loads, use status, and the like. Note that this configuration by distribution or integration may be performed dynamically.

In addition, the above embodiments can be combined as appropriate as long as the processing content does not contradict each other. In addition, the order of the steps illustrated in the flowcharts or the like of the above embodiments can be modified as appropriate.

Furthermore, for example, the present embodiment can be implemented as any configuration including a device or a system, for example, a processor such as a system large scale integration (LSI), a module using a plurality of processors or the like, a unit using a plurality of modules or the like, a set of the like (namely, some components of a device) obtained by further adding another function to a unit.

Note that, in the present embodiment, a system refers to a set of a plurality of components (devices, modules (parts), etc.), and it does not matter whether or not all the components are in the same housing. Therefore, a plurality of devices housed in separate housings and coupled via a network, and one device in which a plurality of modules is housed in one housing are both systems.

Furthermore, for example, the present embodiment can adopt a configuration of cloud computing in which one function is shared and processed by a plurality of devices in cooperation via a network.

### 7. Hardware Configuration

The information devices such as the image processing device 100 according to the embodiments or the modifications described above are implemented by, for example, a computer 1000 having a configuration as illustrated in FIG. 42. FIG. 42 is a hardware configuration diagram illustrating an example of the computer 1000 that implements functions of an information processing device such as the image processing device 100. Hereinafter, the image processing device 100 according to the embodiment will be described as an example. The computer 1000 includes a CPU 1100, a RAM 1200, a read only memory (ROM) 1300, a hard disk drive (HDD) 1400, a communication interface 1500, and an input and output interface 1600. The components of the computer 1000 are connected by a bus 1050.

The CPU 1100 operates in accordance with a program stored in the ROM 1300 or the HDD 1400 and controls each of the components. For example, the CPU 1100 loads a program stored in the ROM 1300 or the HDD 1400 in the RAM 1200 and executes processing corresponding to various programs.

The ROM 1300 stores a boot program such as a basic input output system (BIOS) executed by the CPU 1100 when the computer 1000 is activated, a program dependent on the hardware of the computer 1000, and the like.

The HDD 1400 is a computer-readable recording medium that non-transiently records a program to be executed by the CPU 1100, data used by such a program, and the like. Specifically, the HDD 1400 is a recording medium that records an image processing program according to the present disclosure, which is an example of program data 1450.

The communication interface 1500 is an interface for the computer 1000 to be connected with an external network 1550 (for example, the Internet). For example, the CPU 1100 receives data from another device or transmits data generated by the CPU 1100 to another device via the communication interface 1500.

The input and output interface 1600 is an interface for connecting an input and output device 1650 and the computer 1000. For example, the CPU 1100 receives data from an input device such as a keyboard or a mouse via the input and output interface 1600. The CPU 1100 also transmits data to an output device such as a display, a speaker, or a printer via the input and output interface 1600. Furthermore, the input and output interface 1600 may function as a media interface that reads a program or the like recorded in a predetermined recording medium. A medium refers to, for example, an optical recording medium such as a digital versatile disc (DVD) or a phase change rewritable disk (PD), a magneto-optical recording medium such as a magneto-optical disk (MO), a tape medium, a magnetic recording medium, or a semiconductor memory.

For example, in a case where the computer 1000 functions as the image processing device 100 according to the embodiment, the CPU 1100 of the computer 1000 implements the function of the control unit 130 or other units by executing the image processing program loaded on the RAM 1200. The HDD 1400 also stores the image processing program according to the present disclosure or data in the storage unit. Note that although the CPU 1100 reads the program data 1450 from the HDD 1400 and executes the program data 1450, as another example, these programs may be acquired from another device via the external network 1550.

Furthermore, the image processing device 100 according to the present embodiment may be applied to a system including a plurality of devices based on a premise of connection to a network (or communication between devices), such as cloud computing. That is, the image processing device 100 according to the present embodiment described above can be implemented, for example, as the image processing system 10 according to the present embodiment by a plurality of devices.

An example of the hardware configuration of the image processing device 100 has been described above. Each of the above components may be configured using a general-purpose member or may be configured by hardware specialized in the function of the component. Such a configuration can be modified as appropriate depending on the technical level at the time of implementation.

### 8. Conclusion

Although the embodiments of the disclosure have been described above, the technical scope of the disclosure is not limited to the above embodiments as they are, and various modifications can be made without departing from the gist of the disclosure. In addition, components of different embodiments and modifications may be combined as appropriate.

Furthermore, the effects of the embodiments described herein are merely examples and are not limiting, and other effects may be achieved.

Note that the present technology can also have the following configurations.

(1)

An image processing device comprising:
a control unit that
acquires a plurality of polarized images each having different polarization directions, and
outputs a corrected image in which a specific region included in a specular reflection region is corrected on a basis of the plurality of polarized images.
   (2)

The image processing device according to (1), wherein the specific region includes a region in which an image is reflected in the specular reflection region.

(3)

The image processing device according to (1) or (2), wherein the specific region includes a region designated by a user.

(4)

The image processing device according to any one of (1) to (3), wherein the control unit generates at least one of a specular image having a specular component as a pixel value or a diffused image having a diffusion component as a pixel value on a basis of the plurality of polarized images.

(5)

The image processing device according to (4), wherein the specific region is specified depending on the specular image.

(6)

The image processing device according to any one of (1) to (5), wherein the control unit outputs the corrected image in which a ratio of specific frequency components in frequency components of the specific region is smaller than the ratio of the specific frequency components in the frequency components of a region other than the specific region.

(7)

The image processing device according to any one of (1) to (6), wherein the control unit performs low-pass filter processing on the specific region.

(8)

The image processing device according to any one of (1) to (7), wherein the control unit outputs the corrected image obtained by applying pixelation processing to the specific region.

(9)

The image processing device according to any one of (1) to (8), wherein the control unit outputs the corrected image in which saturation of the specific region is lower than the saturation of a region other than the specific region.

(10)

The image processing device according to any one of (1) to (9), wherein the control unit decreases saturation of the specific region.

(11)

The image processing device according to any one of (1) to (10), wherein the control unit outputs the corrected image obtained by correcting the specific region with an intensity corresponding to a reflected image included in the specific region.

(12)

The image processing device according to (11), wherein the control unit outputs the corrected image obtained by correcting the specific region with the intensity at which the reflected image included in the specific region enters a predetermined state.

(13)

The image processing device according to any one of (1) to (12), wherein the control unit outputs the corrected image in which low-pass filter processing of a filter size corresponding to definition of the specific region is applied to the specific region.

(14)

The image processing device according to any one of (1) to (13), wherein the control unit outputs the corrected image in which pixelation is disposed in an area corresponding to definition of the specific region.

(15)

The image processing device according to any one of (1) to (14a), wherein the control unit outputs the corrected image in which saturation of the specific region is reduced depending on dispersion of the specific region.

(16)

An image processing device comprising:
a control unit that
acquires a plurality of polarized images each having different polarization directions,
specifies a specific region included in a specular reflection region on a basis of the plurality of polarized images, and
outputs an image in which a ratio of specific frequency components in frequency components of the specific region is smaller than the ratio of the specific frequency components in frequency components of a region other than the specific region.
   (17)

An image processing system including:
a sensor that acquires a plurality of polarized images each having different polarization directions; and
an image processing device that outputs a corrected image on the basis of the plurality of polarized images,
in which the image processing device includes:
a control unit that outputs the corrected image in which a specific region included in a specular reflection region is corrected on the basis of the plurality of polarized images.
   (18)

The image processing system according to (17), in which the specific region includes a region in which an image is reflected in the specular reflection region.

(19)

The image processing system according to (17) or (18), in which the specific region includes a region designated by a user.

(20)

The image processing system according to any one of (17) to (19), in which the control unit generates at least one of a specular image having a specular component as a pixel value or a diffused image having a diffusion component as a pixel value on the basis of the plurality of polarized images.

(21)

The image processing system according to (20), in which the specific region is specified depending on the specular image.

(22)

The image processing system according to any one of (17) to (21), in which the control unit outputs the corrected image in which a ratio of specific frequency components in frequency components of the specific region is smaller than the ratio of the specific frequency components in the frequency components of a region other than the specific region.

(23)

The image processing system according to any one of (17) to (22), in which the control unit performs low-pass filter processing on the specific region.

(24)

The image processing system according to any one of (17) to (23), in which the control unit outputs the corrected image obtained by applying pixelation processing to the specific region.

(25)

The image processing system according to any one of (17) to (24), in which the control unit outputs the corrected image in which saturation of the specific region is lower than the saturation of a region other than the specific region.

(26)

The image processing system according to any one of (17) to (25), in which the control unit decreases saturation of the specific region.

(27)

The image processing system according to any one of (17) to (26), in which the control unit outputs the corrected image obtained by correcting the specific region with an intensity corresponding to a reflected image included in the specific region.

(28)

The image processing system according to (27), in which the control unit outputs the corrected image obtained by correcting the specific region with the intensity at which the reflected image included in the specific region enters a predetermined state.

(29)

The image processing system according to any one of (17) to (28), in which the control unit outputs the corrected image in which low-pass filter processing of a filter size corresponding to definition of the specific region is applied to the specific region.

(30)

The image processing system according to any one of (17) to (29), in which the control unit outputs the corrected image in which pixelation is disposed in an area corresponding to definition of the specific region.

(31)

The image processing system according to any one of (17) to (28), in which the control unit outputs the corrected image in which saturation of the specific region is reduced depending on dispersion of the specific region.

(32)

An image processing system including:
a sensor that acquire a plurality of polarized images each having different polarization directions; and
an image processing device that outputs an image on the basis of the plurality of polarized images,
in which the image processing device includes a control unit that;
specifies a specific region included in a specular reflection region on the basis of the plurality of polarized images; and
outputs the image in which a ratio of specific frequency components in frequency components of the specific region is smaller than the ratio of the specific frequency components in frequency components of a region other than the specific region.
   (33)

An image processing method including the steps of:
acquiring a plurality of polarized images each having different polarization directions; and
outputting a corrected image in which a specific region included in a specular reflection region is corrected on the basis of the plurality of polarized images.
   (34)

The image processing method according to (33), in which the specific region includes a region in which an image is reflected in the specular reflection region.

(35)

The image processing method according to (33) or (34), in which the specific region includes a region designated by a user.

(36)

The image processing method according to any one of (33) to (35), the method further including generating at least one of a specular image having a specular component as a pixel value or a diffused image having a diffusion component as a pixel value on the basis of the plurality of polarized images.

(37)

The image processing method according to (36), in which the specific region is specified depending on the specular image.

(38)

The image processing method according to any one of (33) to (37), the method further including outputting the corrected image in which a ratio of specific frequency components in frequency components of the specific region is smaller than the ratio of the specific frequency components in the frequency components of a region other than the specific region.

(39)

The image processing method according to any one of (33) to (38), the method further including performing low-pass filter processing on the specific region.

(40)

The image processing method according to any one of (33) to (39), the method further including outputting the corrected image to which pixelation processing is applied to the specific region.

(41)

The image processing method according to any one of (33) to (40), the method further including outputting the corrected image in which saturation of the specific region is lower than the saturation of a region other than the specific region.

(42)

The image processing method according to any one of (33) to (41), the method further including reducing saturation of the specific region.

(43)

The image processing method according to any one of (33) to (42), the method further including outputting the corrected image in which the specific region is corrected with an intensity corresponding to a reflected image included in the specific region.

(44)

The image processing method according to (43), the method further including outputting the corrected image obtained by correcting the specific region with the intensity at which the reflected image included in the specific region enters a predetermined state.

(45)

The image processing method according to any one of (33) to (44), the method further including outputting the corrected image to which low-pass filtering processing of a filter size corresponding to definition of the specific region is applied to the specific region.

(46)

The image processing method according to any one of (33) to (45), the method further including outputting the corrected image in which a pixelation is disposed in an area corresponding to definition of the specific region.

(47)

The image processing method according to any one of (33) to (46), the method further including outputting the corrected image in which saturation of the specific region is reduced depending on dispersion of the specific region.

(48)

The image processing method including the steps of:
acquiring a plurality of polarized images each having different polarization directions;
specifying a specific region included in a specular reflection region on the basis of the plurality of polarized images; and
outputting an image in which a ratio of specific frequency components in frequency components of the specific region is smaller than the ratio of the specific frequency components in frequency components of a region other than the specific region.
   (49)

An image processing program for causing a computer to function as a control unit that:
acquires a plurality of polarized images each having different polarization directions; and
outputs a corrected image in which a specific region included in a specular reflection region is corrected on the basis of the plurality of polarized images.
   (50)

The image processing program according to (49), in which the specific region includes a region in which an image is reflected in the specular reflection region.

(51)

The image processing program according to (49) or (50), in which the specific region includes a region designated by a user.

(52)

The image processing program according to any one of (49) to (51), in which the control unit generates at least one of a specular image having a specular component as a pixel value or a diffused image having a diffusion component as a pixel value on the basis of the plurality of polarized images.

(53)

The image processing program according to (52), in which the specific region is specified depending on the specular image.

(54)

The image processing program according to any one of (49) to (53), in which the control unit outputs the corrected image in which a ratio of specific frequency components in frequency components of the specific region is smaller than the ratio of the specific frequency components in the frequency components of a region other than the specific region.

(55)

The image processing program according to any one of (49) to (54), in which the control unit performs low-pass filter processing on the specific region.

(56)

The image processing program according to any one of (49) to (55), in which the control unit outputs the corrected image obtained by applying pixelation processing to the specific region.

(57)

The image processing program according to any one of (49) to (56), in which the control unit outputs the corrected image in which saturation of the specific region is lower than the saturation of a region other than the specific region.

(58)

The image processing program according to any one of (49) to (57), in which the control unit decreases saturation of the specific region.

(59)

The image processing program according to any one of (49) to (58), in which the control unit outputs the corrected image obtained by correcting the specific region with an intensity corresponding to a reflected image included in the specific region.

(60)

The image processing program according to (59), in which the control unit outputs the corrected image obtained by correcting the specific region with the intensity at which the reflected image included in the specific region enters a predetermined state.

(61)

The image processing program according to any one of (49) to (60), in which the control unit outputs the corrected image in which low-pass filter processing of a filter size corresponding to definition of the specific region is applied to the specific region.

(62)

The image processing program according to any one of (49) to (61), in which the control unit outputs the corrected image in which pixelation is disposed in an area corresponding to definition of the specific region.

(63)

The image processing program according to any one of (49) to (62), in which the control unit outputs the corrected image in which saturation of the specific region is reduced depending on dispersion of the specific region.

(64)

An image processing program for causing a computer to function as a control unit that:
acquires a plurality of polarized images each having different polarization directions;
specifies a specific region included in a specular reflection region on the basis of the plurality of polarized images; and
outputs an image in which a ratio of specific frequency components in frequency components of the specific region is smaller than the ratio of the specific frequency components in frequency components of a region other than the specific region.

### REFERENCE SIGNS LIST

10 IMAGE PROCESSING SYSTEM
100 IMAGE PROCESSING DEVICE
110 COMMUNICATION UNIT
120 STORAGE UNIT
130 CONTROL UNIT
131 IMAGE ACQUISITION UNIT
132 SPECULAR IMAGE GENERATING UNIT
133 DIFFUSED IMAGE GENERATING UNIT
134, 134A, 134B CORRECTION REGION DETERMINING UNIT
135, 135B CORRECTION PROCESSING UNIT
136 CORRECTED IMAGE GENERATING UNIT
137 IMAGE CORRECTION PROCESSING UNIT
200 SENSOR
1341, 1341B REFLECTION REGION SPECIFYING UNIT
1342 REFLECTED IMAGE REGION SPECIFYING UNIT
1352 INTENSITY DETERMINING UNIT
1343, 1343A CORRECTION REGION SPECIFYING UNIT
1344, 1344B IMAGE POSITION SPECIFYING UNIT
1351 METHOD DETERMINING UNIT
1353 IMAGE CORRECTION UNIT

1. An image processing device comprising:
a control unit that
acquires a plurality of polarized images each having different polarization directions, and
outputs a corrected image in which a specific region included in a specular reflection region is corrected on a basis of the plurality of polarized images.

2. The image processing device according to claim 1, wherein the specific region includes a region in which an image is reflected in the specular reflection region.

3. The image processing device according to claim 1, wherein the specific region includes a region designated by a user.

4. The image processing device according to claim 1, wherein the control unit generates at least one of a specular image having a specular component as a pixel value or a diffused image having a diffusion component as a pixel value on a basis of the plurality of polarized images.

5. The image processing device according to claim 4, wherein the specific region is specified depending on the specular image.

6. The image processing device according to claim 1, wherein the control unit outputs the corrected image in which a ratio of specific frequency components in frequency components of the specific region is smaller than the ratio of the specific frequency components in the frequency components of a region other than the specific region.

7. The image processing device according to claim 1, wherein the control unit performs low-pass filter processing on the specific region.

8. The image processing device according to claim 1, wherein the control unit outputs the corrected image obtained by applying pixelation processing to the specific region.

9. The image processing device according to claim 1, wherein the control unit outputs the corrected image in which saturation of the specific region is lower than the saturation of a region other than the specific region.

10. The image processing device according to claim 1, wherein the control unit decreases saturation of the specific region.

11. The image processing device according to claim 1, wherein the control unit outputs the corrected image obtained by correcting the specific region with an intensity corresponding to a reflected image included in the specific region.

12. The image processing device according to claim 11, wherein the control unit outputs the corrected image obtained by correcting the specific region with the intensity at which the reflected image included in the specific region enters a predetermined state.

13. The image processing device according to claim 1, wherein the control unit outputs the corrected image in which low-pass filter processing of a filter size corresponding to definition of the specific region is applied to the specific region.

14. The image processing device according to claim 1, wherein the control unit outputs the corrected image in which pixelation is disposed in an area corresponding to definition of the specific region.

15. The image processing device according to claim 1, wherein the control unit outputs the corrected image in which saturation of the specific region is reduced depending on dispersion of the specific region.

16. An image processing device comprising:
a control unit that
acquires a plurality of polarized images each having different polarization directions,
specifies a specific region included in a specular reflection region on a basis of the plurality of polarized images, and
outputs an image in which a ratio of specific frequency components in frequency components of the specific region is smaller than the ratio of the specific frequency components in frequency components of a region other than the specific region.
